(19) United States
(12) Patent Application Publication
(10) Pub. No.: US 2003/0154226 A1
(43) Pub. Date: Aug. 14, 2003

(54) Method and system for processing complex numbers

(76) Inventor: Solomon Khmelnik, Ganei Tal (IL)

Correspondence Address: DOWELL & DOWELL, P.C., Suite 309, 1215 Jefferson Davis Highway, Arlington, VA, 22202, US

(21) Appl. No.: 10/189,195

(22) Filed: Jul. 5, 2002

Related U.S. Application Data
(63) Continuation of application No. PCT/CA01/0007, filed on Jan. 5, 2001.

(30) Foreign Application Priority Data
Jan. 5, 2000 (CA) 2,293,953

(51) Int. Cl. G06F 7/38

(52) U.S. Cl. 708/490; 708/204

(57) ABSTRACT

The invention provides a method and apparatus for storing complex number data in formats or codes which allow efficient complex number arithmetic operations to be performed and for performing such complex number arithmetic operations. According to one aspect of the invention, a method for coding complex numbers is provided for use in a data processing system. In response to receiving an instruction, two data elements representing the real and imaginary parts of a complex number are read. These two elements are then used to generate a single code for the complex number which is stored as a single data element. As a result of this coding, arithmetic operations on complex numbers may be performed on a single data element which contains both real and imaginary data. According to another aspect of the invention, a coprocessor is described. This coprocessor has stored therein data representing sequences of instructions which, when combined with certain unique circuitry also contained therein and executed, cause the coprocessor to perform the above described method and to perform complex number arithmetic operations.

The invention relates to the field of data processing systems. More specifically, the invention relates to a coprocessor for performing arithmetic operations on complex numbers.

### BACKGROUND OF THE INVENTION

Arithmetic operations involving complex numbers are commonly required in data processing systems used in fields as varied as power system control, underwater acoustics, tomography, laser holography, 3D graphics, navigation, and theoretical physics. These operations may include addition, subtraction, multiplication, division, comparison, logarithms, binomials, potentiating, square roots, cube roots, sine, cosine, hyperbolic functions, polar/cartesian coordinates, and fast fourier transforms, to name a few.

A complex number Z may be represented by a real part Xa and an imaginary part Xb, where Z=Xa+j Xb, and where Xa and Xb are real numbers (positive or negative) and j=(−1)\hat{ }(½). Problems related to efficiently performing arithmetic operations arise as the complex number represents a vector rather than a scalar quantity. That is, for each complex variable involved in a given arithmetic operation, two components of the number must be considered, its real and imaginary parts, rather than the one real component that would be involved for each number in an operation involving just real numbers. For example, given two real numbers Xa1 and Xa2, their sum is given by Xa1+Xa2 and their product by Xa1*Xa2. However, for two complex numbers Z1=Xa1+jXb1 and Z2=Xa2+jXb2, their sum and product are given by the more complicated expressions (Xa1+Xa2)+j(Xb1+Xb2) and (Xa1*Xa2−Xb1*Xb2)+j(Xa1*Xb2+Xb1*Xa2), respectively. It is apparent that arithmetic operations involving complex numbers require significantly greater data processing system resources.

In the prior art, methods of packing data and performing specific arithmetic operations on complex numbers have been disclosed. For example, U.S. Pat. No. 5,936,872 (Fischer et al.) describes a method and apparatus for storing complex numbers in packed form and performing packed operations thereon to allow for their efficient multiplication. In Fischer, the real and imaginary parts of a complex number are manipulated individually in the performance of the multiplication operation. In other words, the real and imaginary parts of the complex number are treated as separate data elements.

The real and imaginary parts of a complex number are stored in binary format in the standard base 2 format or code. In general, a real number Xa may be expressed in base 2 by the code K(Xa)= . . . a(m) . . . a(2), a(1), a(0), a(−1), a(−2) . . . , where m is the mth digit in the code, a(m)={0,1}, and Xa=Sum(m)[a(m)*2\hat{ }m]. Thus K(Xa) is simply a standard binary representation of the number Xa as a sequence of coefficients of successive powers of the base. This coding system may be represented symbolically by the function f(p,m)=p\hat{ }m, where p is the base and m is the mth digit. Under this coding system, for example, if Xa=7, one could write Xa=(1*2\hat{ }2)+(1*2\hat{ }1)+(1*2\hat{ }0) or the code K(Xa)=K(7)=111. As another example, if Xb=4, one could write Xb=(1*2\hat{ }2)+(0*2\hat{ }1)+(0*2\hat{ }0) or the code K(Xb)=K(4)=100. And, for a complex number Z=Xa+jXb=7+j4, one could write K(Z)=K(7+j4)=(111)+j (100). In this base 2 system, therefore, the code for the complex number has two separate data elements associated with it (i.e. one data element for the real part and one data element for the imaginary part). Arithmetic operations performed on these individual data elements are very cumbersome.

There is thus a need for a method and system of more efficiently representing or coding complex numbers and an apparatus for performing arithmetic operations on these coded complex numbers that will improve the efficiency of arithmetic operations involving complex numbers in data processing systems. It is desirable to perform arithmetic operations on complex numbers that are represented by a single data element (i.e. one data element for both the real and imaginary parts).

### SUMMARY OF THE INVENTION

In accordance with this invention there is provided a method and apparatus for storing complex number data in formats or codes which allow efficient complex number arithmetic operations to be performed and for performing such complex number arithmetic operations. According to one aspect of the invention, a method for coding complex numbers is provided for use in a data processing system. In response to receiving an instruction, two data elements representing the real and imaginary parts of a complex number are read. These two elements are then used to generate a single code for the complex number which is stored as a single data element. As a result of this coding, arithmetic operations on complex numbers may be performed on a single data element which contains both real and imaginary data. According to another aspect of the invention, a coprocessor is described. This coprocessor has stored therein data representing sequences of instructions which, when combined with certain unique circuitry also contained therein and executed, cause the coprocessor to perform the above described method and to perform complex number arithmetic operations.

### BRIEF DESCRIPTION OF THE DRAWINGS

The invention may best be understood by referring to the following description and accompanying drawings which illustrate the invention. In the drawings:

FIG. 1.1. is a graphical representation of four basic function values in a first coding system;

FIG. 1.2. is a graphical representation of four basic function values in a second coding system;

FIG. 1.3. is a graphical representation of four basic function values in a third coding system;

FIG. 1.4. is a graphical representation of four basic function values in a fourth coding system;

FIG. 2.1. shows a block diagram illustrating the computation of the k th digit in accordance with algorithm 2.1;

FIG. 2.2. shows a block diagram illustrating the Carry Distribution Pattern in accordance with algorithm 2.1;

FIG. 2.3. shows a block diagram illustrating the Carry Distribution Pattern in the first and second coding system;

FIG. 2.4. shows a block diagram illustrating the computation of the k th digit in accordance with algorithm 2.2;

FIG. 2.6. shows a. block diagram illustrating the Carry Distribution Pattern in the third coding system;

FIG. 2.7. shows a block diagram illustrating the Carry Distribution Pattern in the fourth coding system;

FIG. 2.8. shows a block diagram illustrating a unit for successive multiplication of complex numbers;

FIG. 2.9. shows a block diagram illustrating a unit for the matrix multiplication of complex numbers;

FIG. 3.1. illustrates the Elementary Operations Sequence of Algorithm 3.1;

FIG. 4.1. shows a block diagram illustrating an exemplary comparison unit for low-digit complex codes by the modulus;

FIG. 4.2. 9 shows a block diagram illustrating an exemplary unequal high-order digit number comparison unit;

FIG. 4.3. shows a block diagram illustrating an exemplary comparison unit for multidigit complex codes by the modulus;

FIG. 4.4. shows a block diagram illustrating an exemplary algebraic adder of M-codes;

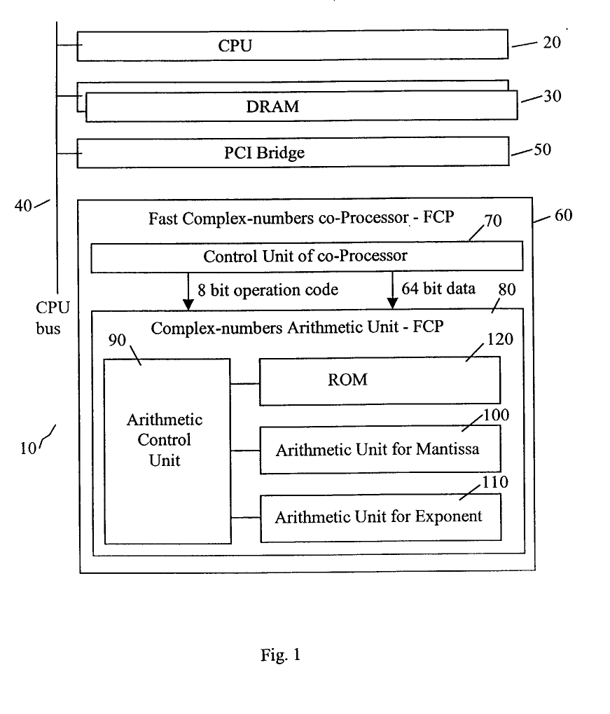

FIG. 1 shows a block diagram illustrating an exemplary data processing system including a complex number coprocessor according to one embodiment of the invention;

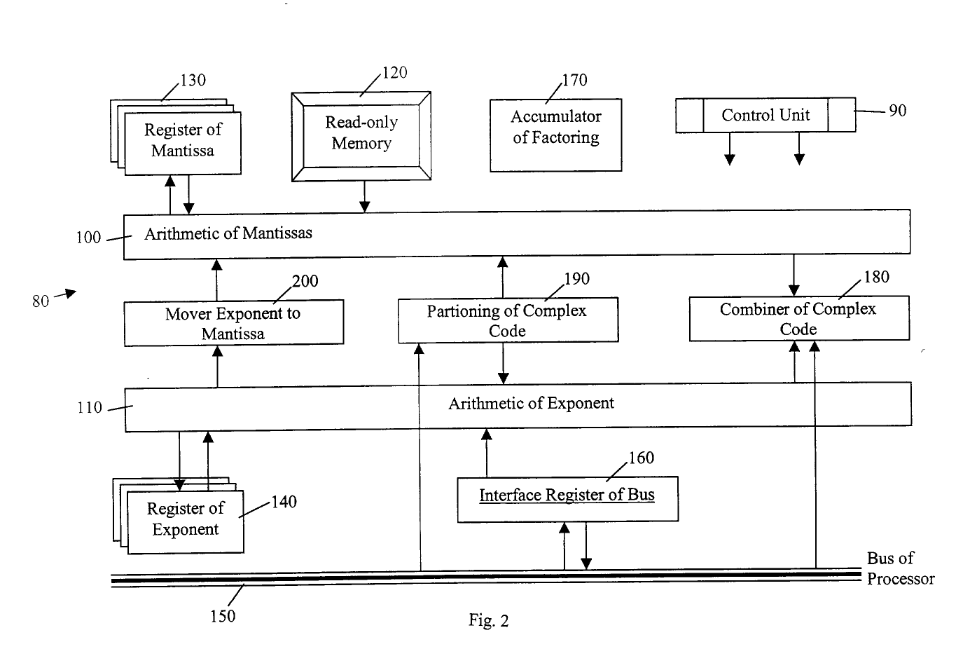

FIG. 2 shows a block diagram illustrating an exemplary complex number coprocesser arithmetic unit;

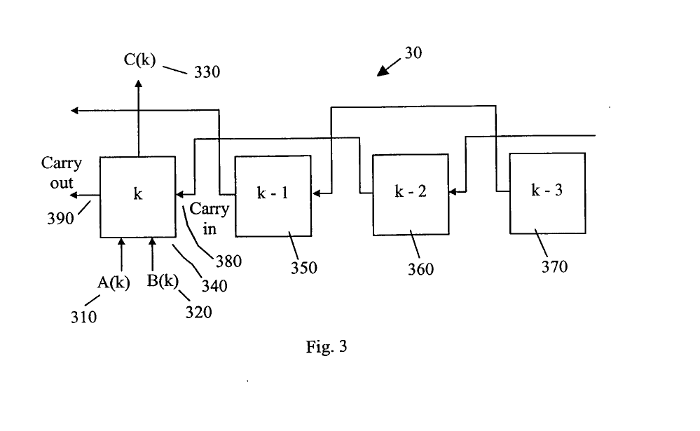

FIG. 3 illustrates exemplary circuitry for carry-in determination in the coding system where p=−2, p=j*(2\hat{ }(½)), or p=−j*(2\hat{ }(½));

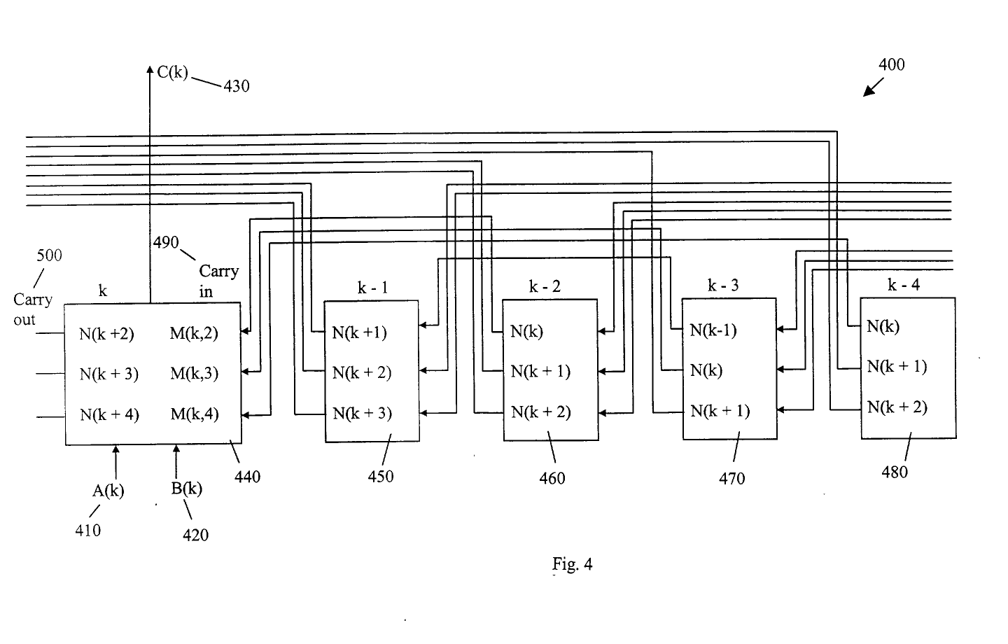

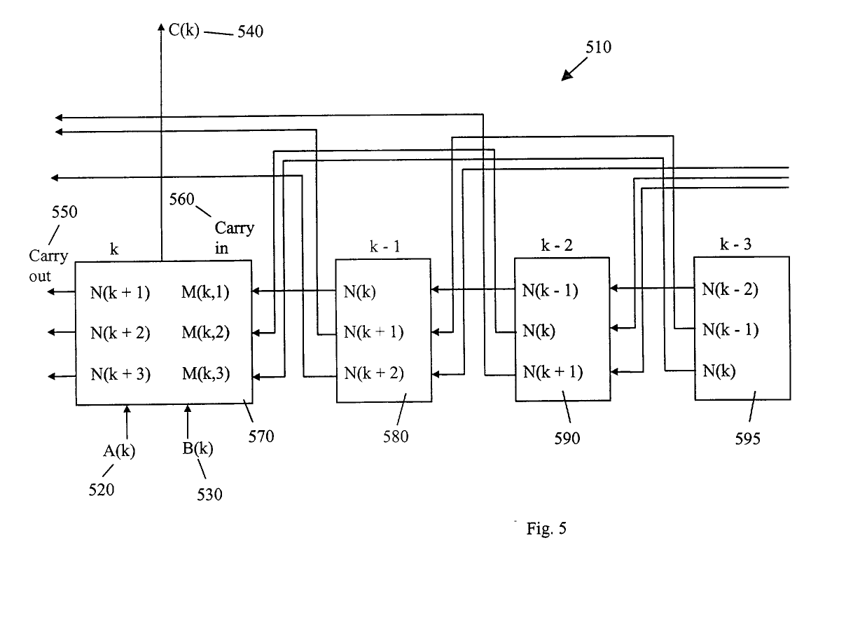

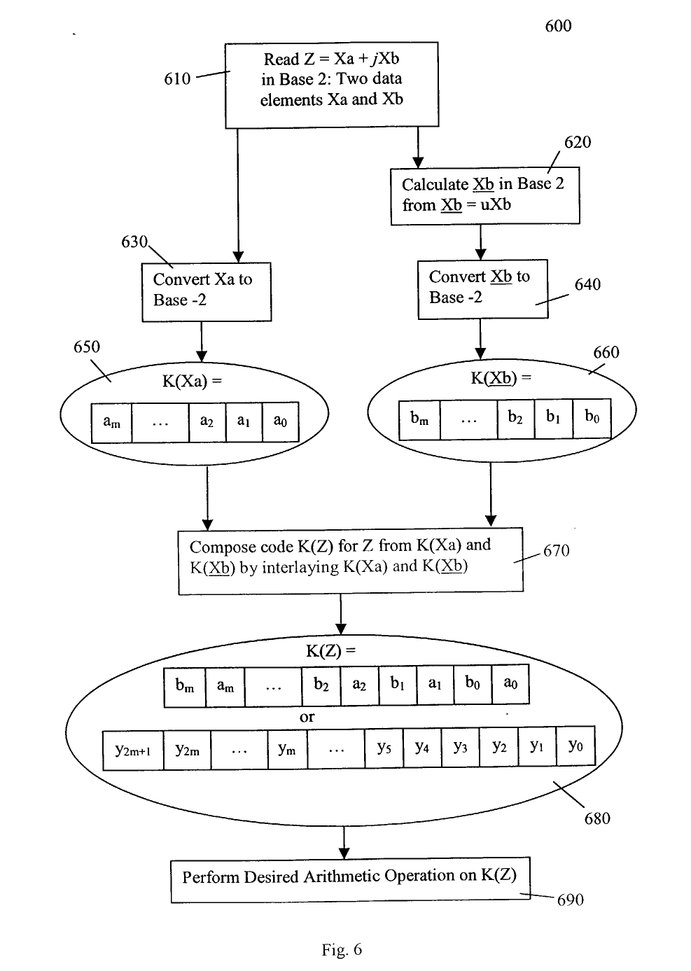

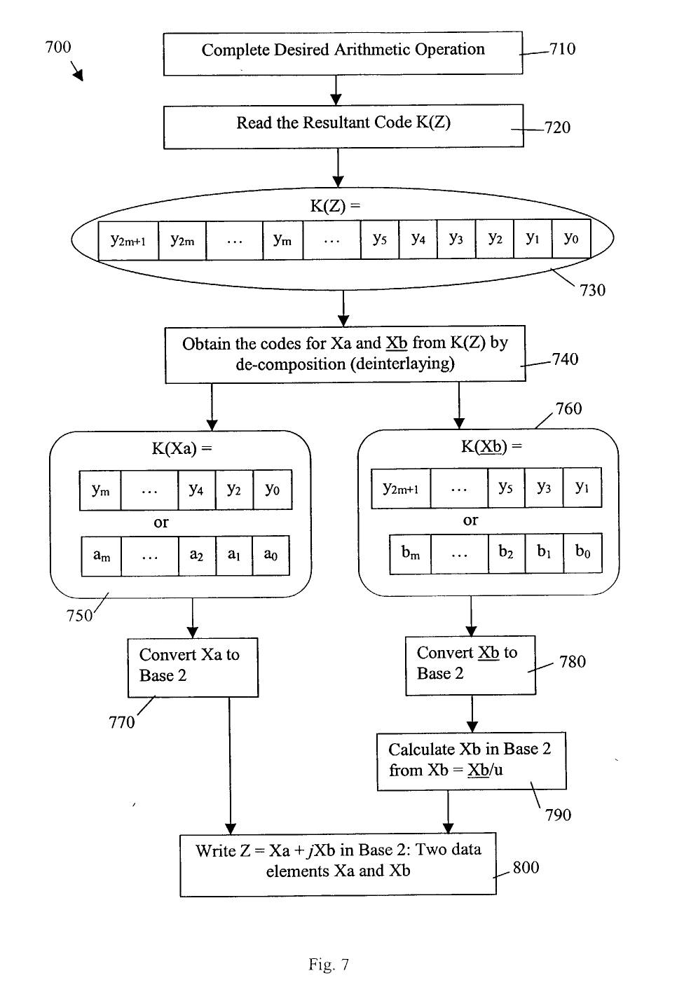

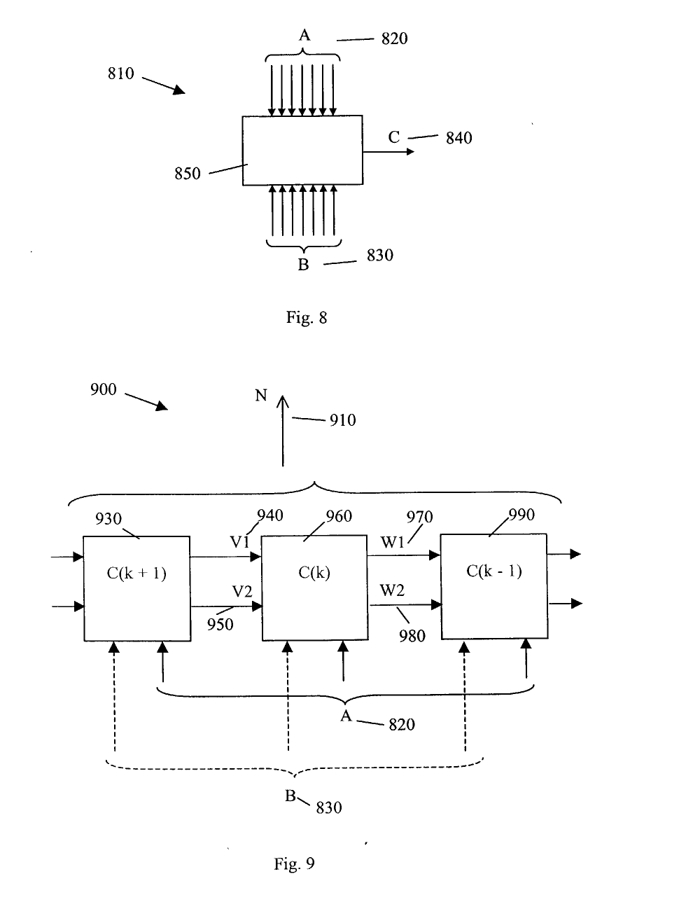

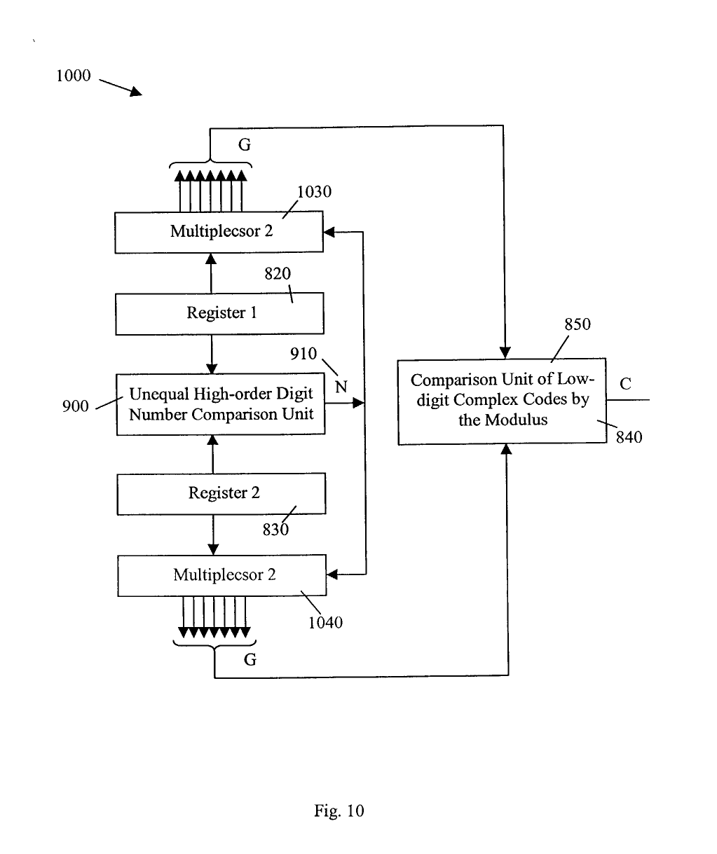

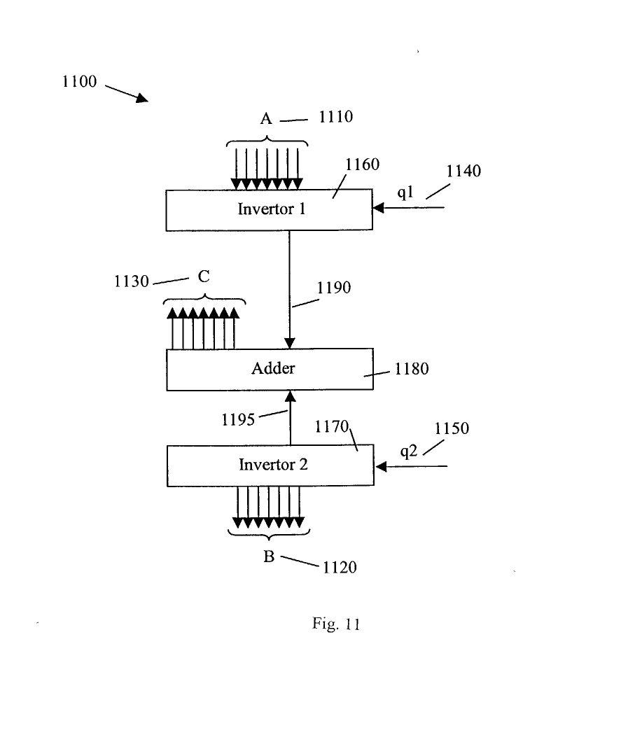

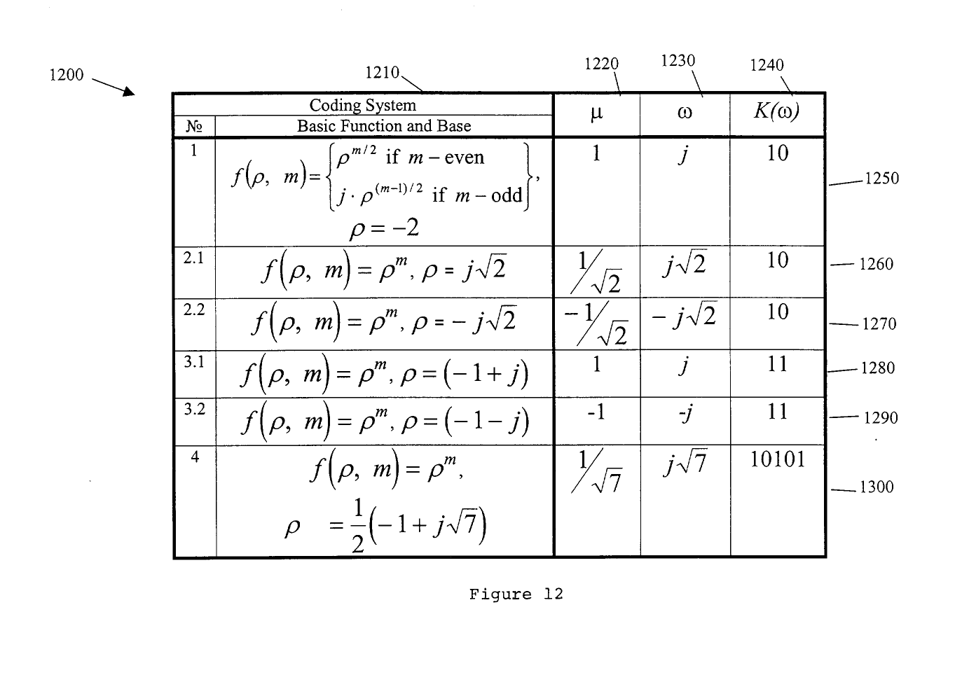

FIG. 4 illustrates exemplary circuitry for carry-in determination in the coding system where p=−1+j or p=−1−j;

FIG. 5 illustrates exemplary circuitry for carry-in determination in the coding system where p=½*(−1+j*(7\hat{ }(½)));

FIG. 6 illustrates the coding method steps according to one embodiment of the invention;

FIG. 7 illustrates the decoding method steps according to one embodiment of the invention;

FIG. 8 shows a block diagram illustrating an exemplary comparison unit for low-digit complex codes by the modulus;

FIG. 9 shows a block diagram illustrating an exemplary unequal high-order digit number comparison unit;

FIG. 10 shows a block diagram illustrating an exemplary comparison unit for multidigit complex codes by the modulus;

FIG. 11 shows a block diagram illustrating an exemplary algebraic adder of M-codes;

FIG. 12 shows a table listing formula for six coding systems according to one embodiment of the invention.

### DETAILED DESCRIPTION OF PREFERRED EMBODIMENTS

In order to better understand the invention, a theoretical description is presented first. This is followed by a description of the preferred embodiment.

Theoretical Description

The following theoretical description will address the following matters:

1. Complex numbers coding method

1.1. General Provisions

1.2. Coding System 1

1.3. Coding System 2

1.4. Coding System 3

1.5. Coding System 4

2. Arithmetic Operations With Complex Number Codes

2.1. Bitwise Operations

2.2. First Bitwise Operation Algorithm

2.3. Second Bitwise Operation Algorithm

2.4. Coding and Decoding of Complex Numbers

2.5. Multiplication of Complex Numbers

3. Division and Computation of Elementary Functions of a Complex Variable

3.1. “Digit by Digit” Method

3.2. Decomposition

3.3. Composition

3.4. Two-step Operations

3.5. Computational Algorithms

3.5.1. Division of Complex Numbers

3.5.2. Determination of the Natural Logarithm of a Complex Number (Option 1)

3.5.3. Determination of the Natural Logarithm of a Complex Number (Option 2)

3.5.4. Computation of Complex Number Modulus Logarithm

3.5.5. Computation of Complex Number Argument (Option 1)

3.5.6. Complex Number Square-rooting

3.5.7. Computation of Complex Number Argument (Option 2)

3.5.8. Conjugated Number Square-rooting

3.5.9. Computation of Complex Number Modulus

3.5.10. Complex Number Exponentiation

3.5.11. Transformation of Polar Coordinates into Rectangular Ones

3.5.12. Transition of Polar Coordinates to Rectangular Ones

4. Processor Structure

4.1. Data Representation

4.2. Microprogrammed Control Unit

4.3. Operational Units

4.3.1. Comparison Unit of Low-digit Complex Codes by the Modulus

4.3.2. Unequal High-order Digit Number Comparison Unit

4.3.3. Comparison Unit of Multidigit Complex Codes by the Modulus

4.3.4. Algebraic Adder of M-codes

1. Complex Numbers Coding Method

1.1. General Provisions

The following method of positional coding of complex numbers is proposed. A complex number, Z, is represented by decomposition in the form of

$$Z = {\sum }_{m} {α}_{m} f ( ρ , m ) , \qquad \text{(1.1)}$$

where

m is the number of the decomposition digit,

αₘ={0, 1} is the decomposition digit value,

ρ is the decomposition base, and

ƒ(ρ, m) is the basic function of the number and base.

The binary positional code of the complex number, Z, relevant to this decomposition looks like this:

K(Z)= . . . αₘ . . . (1.2)

We will also designate and record the positional code of the complex number, Z, to the ρ base as follows:

<Z>_{ρ}=αₙ . . . αₖ . . . α₁α₀,α₋₁α₋₂ . . . αₘⱼ,

placing the point between the zero and the (−1) digits (the base index will not be specified if the base value is clear from the context). The complex number, Z, in the code of which m≧0, will be designated as a ρ-integer. The ρ-fractionals (proper and improper) of the complex number, Z, will be determined accordingly. In particular

<ρ>_{ρ}=10 (1.3)

Positional codes of real positive numbers are well-known. Positional codes to the base of (−2) for real positive and negative numbers are also known. For complex numbers, the different positional numerical systems with real and complex bases will be built further on. The symbol, j, will be used to designate an imaginary unit therein.

The most interesting among positional coding systems are those, to which simple algorithms of addition and multiplication are applicable. We shall consider these systems further, referring to them as arithmetical, but first we have to define them more precisely.

Definition. A positional coding system is referred to as arithmetical, if it satisfies the following statement: If the numbers Z₁ and Z₂ can be represented in the positional coding system, then the numbers −Z₁, −Z₂, Z₁+Z₂ and Z₁Z₂ can also be represented in this system.

Lemma. A numerical system is arithmetical if

$$\begin{matrix}2 = {\sum }_{k = 1}^{n} {α}_{k} {f ( ρ , k )}^{k} , & \text{(1.4)} \\ - 2 = {\sum }_{k = 1}^{w} {β}_{k} {f ( ρ , k )}^{k} , & \text{(1.5)}\end{matrix}$$

2=Σₖ₌₁ⁿαₖƒ(ρ,k)^{k} (1.4)

−2=Σₖ₌₁^{w}βₖƒ(ρ,k)^{k} (1.5)

i.e. the codes of numbers (2) and (−2) are ρ-integers with a zero value of the zero digit. Validity of this lemma, as will be shown further, follows from the fact that there exist arithmetical operation algorithms for such systems.

Theorem. A numerical system, in which the number, (2), is decomposed as per (1.4) and

$$2 = {\sum }_{k = 1}^{m} {α}_{k} , \qquad \text{(1.6)}$$

2=Σₖ₌₁^{m}αₖ, (1.6)

is arithmetical.

Proof. It follows from (1.4) and (1.5) that the theorem deals with systems where the number 2 has an integral code, which contains precisely two unit digits (and any number of zero digits).

Let us consider, for example, the following algorithm of code formation of (−2):

$$\begin{matrix}1010 & carries \\ 1010 & carries \\ 1010 & carries \\ 1010 = {⟨ 2 ⟩}_{ρ} & summand 1 \\ 110 = {⟨ X ⟩}_{ρ} & summand 2 \\ 00000000 & sum\end{matrix}$$

Here the number 2 code is added to the code of a certain number, X, the digits whereof are generated so that the sum of numbers in the column would equal 2. At the same time, and due to (1.6), the numbers in each column add up to 2, which forms the carry to zero digit of the sum. As a result, infinite carries are formed, and a zero sum. Consequently, X=−2. Obviously, such a formation algorithm is always executable if theorem conditions are fulfilled. This algorithm results in the number (−2) code of (1.5) type. Consequently, conditions of the lemma are fulfilled and the system is arithmetical. And thus the theorem is proved.

The theorem will be further used for positional coding systems search.

1.2. Coding System I

Let X_{α} and X_{β} be real (positive and negative) numbers, specified by decompositions to the base of p=−2, i.e.

$${X}_{α} = {\sum }_{( m )} {α}_{m} {ρ}^{m} , {X}_{β} = {\sum }_{( m )} {β}_{m} {ρ}^{m} \qquad ( 1.7 )$$

These decompositions have corresponding codes

K(X_{α})= . . . αₘ . . . ,K(X_{β})= . . . βₘ . . . (1.8)

In particular, in the real numbers coding system to the base of (−2), the code is K(2)=110, i.e. it is arithmetical.

Let us designate a pair of digits, αₘ and βₘ, by one number, σₘ. The code

K(Z)= . . . σₘ . . . (1.9)

of the complex number, Z=X_{α}+jX_{β}, is generated to the base of ρ=−2 with the σₘ digits assuming one of these four values: σₘε{0, 1, j, 1+j}.

Let us review the complex function

$$f ( ρ , m ) = \{ \begin{matrix}{ρ}^{m / 2} & if m - even \\ j \cdot {ρ}^{( m - 1 ) / 2} & if m - odd\end{matrix} \} \qquad ( 1.10 )$$

Here the code (1.9) of the complex number to the base of ρ=−2 with complex digit values may be viewed as a complex number binary code with basic function (1. 10) and binary digits. Decomposition of the complex number in the form of

$$Z = {\sum }_{m} {γ}_{m} \cdot f ( ρ , m ) , \qquad \text{(1.11)}$$

corresponds with this code where binary digits are

$${γ}_{m} = \{ \begin{matrix}{α}_{m} & if m - even \\ j \cdot {β}_{m} & if m - odd\end{matrix} \} \qquad ( 1.12 )$$

As an illustration, let us write down the codes of some typical numbers using this system:

K(2)=10100, K(−2)=100, K(−1)=101, K(j)=10, K(−j)=1010, K(2j)=101000.

Reviewed further will be coding systems to the complex base, ρ, where the basic function is ƒ(ρ, m)=ρ^{m}.

1.3. Coding System 2

Let us review the real (positive and negative) numbers, X_{α} and X_{β} (as in System 1), set by the decompositions in (1.7) and the codes in (1.8) to the base, ρ=−2.

Let us build a sequence of alternating digits αₘ and βₘ:

. . . βₘ₊₁αₘ₊₁βₘαₘβₘ₋₁αₘ₋₁ . . .

Designating αₘ=σ₂ₘ and βₘ=σ₂ₘ₊₁, let us transcribe the above sequence in a different form:

. . . σₖ₊₃σₖ₊₂σₖ₊₁σₖ₋₁σₖ₋₂ . . . ,

where k=2m. This sequence is a binary code

K(Z)= . . . σₘ . . .

of a certain complex number, Z=X_{α}+jX_{β}, to the base, ρ=±j\sqrt{2}.

As an illustration, let us write down the codes of some typical numbers using this system, ρ=j\sqrt{2}:

K(2)=10100, K(−2)=100, K(−1)=101, K(j\sqrt{2})=10, K(−j\sqrt{2})=1010.

1.4. Coding System 3

Any complex number may be represented within the normal coding system to the complex base, ρ, and this system is arithmetical if

ρ=(−1±j) or ρ=\sqrt{2}e^{±jπ/2}.

To prove this statement, it is sufficient to show that K(2)=1100. This relationship is equivalent to the following:

ρ³+ρ²=2.

In proving it, we should note that ρ²=∓2j and ρ³=(2±2j). Once these formulae are introduced into the previous equation, it is easy to ascertain its correctness. Thus the conditions of Theorem 1 are satisfied and, consequently, this coding system is arithmetical.

As an illustration, let us write down the codes of some typical numbers using the system with the ρ=(j−1) base, designating as \overline{ρ} the number conjugated with the number ρ:

K(2)=1100, K(−2)=11100, K(−1)=11101, K(j)=1, K(−j)=111, K(\overline{ρ})=110.

1.5. Coding System 4

Any complex number may be represented within the normal coding system to the complex base, ρ, and this system is arithmetical if

$$ρ = \frac{1}{2} ( - 1 + j \sqrt{7} )$$

or ρ=\sqrt{2}e^{jφ}, where φ=areCos(−1/2\sqrt{2}).

To prove this statement, it is sufficient to show that K(2)=1010. This relationship is equivalent to the following:

ρ³+ρ=2.

In proving it, we should note that

$${ρ}^{2} = \frac{1}{2} ( - 3 - j \sqrt{7} ) and {ρ}^{3} = \frac{1}{2} ( 5 - j \sqrt{7} ) .$$

Once of the preceding formula has been introduced into the equation being proved, it is easy to ascertain its correctness. Thus, the three conditions of the theorem are satisfied and, accordingly, this coding system is arithmetical.

As an illustration, let us write down the codes of some typical numbers using this system, denoting as \overline{ρ} the number conjugated with the number, ρ:

K(2)=1010, K(−2)=110, K(−1)=111, K(\overline{ρ})=101, K(−ρ)=1110, K(−\overline{ρ})=11,

K(j\sqrt{7})=10101, K(−j\sqrt{7})=1110011.

FIGS. 1.1, 1.2, 1.3 and 1.4 show the first 4 basic function values in each binary system of coding complex numbers.

2. Arithmetic Operations with Complex Number Codes

2.1. Bitwise Operations

Let Z1 and Z2 be random complex numbers, Z=Z1 delta Z2 (2.1)—the result of operation delta with them, and let the position codes of these complex numbers within the arithmetic system appear as

K(Z1)= . . . a(k) . . . , K(Z2) . . . b(k) . . . , K(Z)= . . . sigma(k) . . .

Let us consider the class of bitwise operations, i.e. operations of addition, subtraction, multiplication by a constant ρ-integer coefficient and inversion, i.e. multiplication by ‘−1’. The bitwise operation delta is carried out sequentially with each pair of numbers a(k) and b(k) (ah digits of the initial codes) taking into account the carry from low-digit positions using the following formula:

S(k)=Q(k)+P(k), (2.2)

where

Qₖ=αₖΔβₖ is the result of operation Δ with k^{th} digits,

ρ is the carry from the low-digit position to the k^{th} digit,

Sₖ is the resulting digit.

The resulting digit can always be represented as

Sₖ=σₖ+ρPₖ₊₁, (2.3)

where

sigma(k) is the k^{th} digit of the resulting code,

P(k+1) is the carry from the k^{th} digit to the (k+1)^{th} digit.

Obviously, in order not to allow carries from high- to low-order digits, the value of P(k+1) must be a ρ-integer with any k. Consequently, the values of Sₖ and Qₖ must also be ρ-integers. To meet all of these conditions, it is necessary and sufficient for just the Qₖ value to be a ρ-integer.

Thus the operation with positional codes is a bitwise one if two conditions are met:

(αₖΔβₖ)ρ^{k}=αₖρ^{k}Δβₖρ^{k},

Qₖ is a ρ-integer.

There are two methods of determining the carry values, and thus the bitwise operation may be performed using two different algorithms.

2.2. First Bitwise Operation Algorithm

Assume that <Sₖ>=γₘ . . . γⱼ . . . γ₁γ₀, where γⱼ—digits 0, 1. Then according to (2.3),

σₖ=γ₀, (2.4)

<Pₖ₊₁>=μₘ₋₁ . . . μⱼ . . . μ₀, (2.5)

where μⱼ₋₁=γⱼ. Using the resulting relationships, we can make a sequence of elementary operations for calculations in the k^{th} digit:

Algorithm 2.1. αₖ, βₖ, Pₖ are known quantities.

1. Determine Qₖ=αₖΔβₖ.

2. Determine Sₖ according to (2.2).

3. Determine the code <Sₖ>.

4. Determine σₖ according to (2.4).

5. Determine the code <Pₖ₊₁>of the (2.5) type.

6. Determine Pₖ₊₁ by the <Pₖ₊₁> code.

7. Carry out operations 1 through 6 for the (k+1)^{th} digit.

FIG. 2.1 shows the diagram of computations in the k^{th} digit, and FIG. 2.2 illustrates the pattern of carry distribution per Algorithm 2.1.

The resulting form of the algorithm's transcription does not provide a clear understanding of its complexity and specifics, and is inconvenient for practical applications. For this reason it is used only for obtaining another form of recording the algorithm, by constructing a table that describes the bitwise operation within a single digit. This table is complete only if it meets the following two conditions:

if the Pₖ₊₁ carry has a certain value, then the Pₖ carry also assumes the same value;

the table contains any possible combination of values of αₖ, βₖ and Pₖ.

These conditions will be referred to further on as conditions of completeness of the bitwise operations table. Let us review some examples of bitwise operations table synthesis using Algorithm 2.1 and computations performed using these tables.

Example 2.1. Code inversion within the system, ρ=−1+j. We have a code, K(Z)= . . . αₖ . . . We need to determine the code, K(−Z)= . . . σₖ . . . Obviously, Qₖ=αₖ. Using Algorithm 2.1, we compile Table 2.1, which satisfies the conditions of completeness: carries Pₖ and Pₖ₊₁ assume values from the overall five-element set, P={0, 1, j, −1, 1+j} and the table contains all possible number pairs, one of which belongs to the {0, 1} set and the other to the P set. Using Table 2.1 we can easily invert any code of this system. An example is provided in Table 2.1A.

TABLE 2.1

| αₖ | Pₖ | Qₖ | Sₖ | <Pₖ₊₁> | σₖ | Pₖ₊₁ |
|---|---|---|---|---|---|---|
| 0 | 0 | 0 | 0 | 0 | 0 | 0 |
| 1 | 0 | −1 | −1 | 1110 | 1 | 1 + j |
| 0 | 1 + j | 0 | 1 + j | 111 | 0 | −j |
| 1 | 1 + j | −1 | j | 1 | 1 | 1 |
| 0 | −j | 0 | −j | 11 | 1 | j |
| 1 | −j | −1 | −1 − j | 11 | 0 | j |
| 0 | j | 0 | j | 1 | 1 | 1 |
| 1 | j | −1 | −1 + j | 1 | 0 | 1 |
| 0 | 1 | 0 | 1 | 0 | 1 | 0 |
| 1 | 1 | −1 | 0 | 1110 | 1 | 1 + j |

TABLE 2.1A

| | | | | | | | | | |
|---|---|---|---|---|---|---|---|---|---|
| Carries | 1 | 1 + j | 0 | 0 | 1 | j | −j | 1 + j | |
| Code | 1 | 1 | 1 | 0 | 0 | 1 | 0 | 0 | 1 |
| Result | | 1 | 1 | 0 | 1 | 0 | 1 | 0 | 1 |

Example 2.2. Addition of codes in System 4. In this case Qₖ=αₖ+βₖ assumes three values: {0, 1, 2}. Using Algorithm 2.1, we compile Table 2.2, which describes the process of addition. In order to reduce its size:

no αₖ and βₖ digit combinations adding up to Qₖ were entered;

the value of Sₖ was not given and only the <Sₖ> code was entered;

the <Sₖ> code was recorded in the cell located at the crossing of column Qₖ and line Pₖ (e.g. if Qₖ=1 and Pₖ=ρ, the code is <Sₖ=1+ρ>=101).

This table satisfies the conditions of completeness since it contains all possible combinations of values of Qₖ and Pₖ, and the <Pₖ> code assumes the same values as the <Pₖ₊₁> code, which consists of higher-order digits of the <Sₖ> code (e.g. if <Sₖ>=1110, the code is <Pₖ₊₁>=111, but the <Pₖ>=111 code is also represented in the table). An example is provided in Table 2.2A.

TABLE 2.2

| | | Code <Sₖ> if | | |
|---|---|---|---|---|
| Pₖ | <Pₖ> | Qₖ = 0 | Qₖ = 1 | Qₖ = 2 |
| 0 | 0 | 0 | 1 | 1010 |
| 1 | 1 | 1 | 1010 | 1011 |
| ρ | 10 | 10 | 11 | 11100 |
| −\overline{ρ} | 11 | 11 | 11100 | 11101 |
| ρ² | 100 | 100 | 101 | 1110 |
| \overline{ρ} | 101 | 101 | 1110 | 1111 |
| −1 | 111 | 111 | 0 | 1 |
| −ρ | 1110 | 1110 | 1111 | 1000 |

TABLE 2.2A

| | | | | | | | | | | |
|---|---|---|---|---|---|---|---|---|---|---|
| Carries | | | | | \overline{ρ} | −1 | −ρ | ρ | \overline{ρ} | |
| Summand. | | | 1 | 0 | 0 | 0 | 0 | 1 | 0 | 1 |
| 1 | | | | | | | | | | |
| Summand. | | 1 | 0 | 0 | 0 | 0 | 1 | 1 | 0 | 1 |
| 2 | | | | | | | | | | |
| Sum | 1 | 1 | 1 | 0 | 1 | 1 | 1 | 0 | 1 | 0 |

Example 2.3. Subtraction of codes in System 4. In this case Qₖ=αₖ−βₖ assumes these values: {0, −1, −2}. Using Algorithm 2.1 we compile Table 2.3, which describes the process of subtraction.

TABLE 2.3

| | | Code <Sₖ> if | | |
|---|---|---|---|---|
| Pₖ | <Pₖ> | Qₖ = 0 | Qₖ = −1 | Qₖ = 1 |
| 0 | 0 | 0 | 111 | 1 |
| 1 | 1 | 1 | 0 | 1010 |
| ρ | 10 | 10 | 111001 | 11 |
| −\overline{ρ} | 11 | 11 | 10 | 11100 |
| −ρ² | 11100 | 11100 | 11 | 11101 |
| −ρ² | 101 | 101 | 100 | 1110 |
| −1 | 111 | 111 | 110 | 0 |
| −ρ | 1110 | 1110 | 101 | 1111 |

Example 2.4. Inversion of codes in System 4. In this case Qₖ=−αₖ assumes two values: {0, −1}. Using Algorithm 2.1 we compile Table 2.4, which describes the process of inversion.

TABLE 2.4

Code <Sₖ> if

| Pₖ | <Pₖ> | Qₖ = 0 | Qₖ = −1 |
|---|---|---|---|
| 0 | 0 | 0 | 111 |
| 1 | 1 | 1 | 0 |
| −\overline{ρ} | 11 | 11 | 10 |

Example 2.5. Algebraic addition of codes in Systems 1 and 2. Note that in these systems K(2)=10100, K(−2)=100 and K(−1)=101. Taking into account the method of coding in these systems and the type of codes used, we can observe that algebraic addition in these systems is performed according to the rules of algebraic addition in the coding system of real numbers to the base of ρ=−2, where K(2)=110, K(−2)=10 and K(−1)=11.

In case of reverse addition, Qₖ=−αₖ−βₖ assumes these values: {0, −1, −2}. Using Algorithm 2.1, we compile Table 2.5, which describes the process of reverse addition. Particularly, Qₖ=−αₖ, when inverted, assumes two values: {0, −1}. In Table 2.5 the part having to do with inversion was specially marked.

Based on Table 2.5, we compiled the truth Table 2.5A of single-digit circuits for reverse addition of codes in this system. The part having to do with inversion has also been specially marked in it.

FIG. 2.3 illustrates the pattern of carry distribution within the single-digit complex code circuits in this system.

TABLE 2.5

| | | Code <Sₖ> if | | |
|---|---|---|---|---|
| Pₖ | <Pₖ> | Qₖ = 0 | Qₖ = −1 | Qₖ = −2 |
| 0 | 0 | 0 | 11 | 10 |
| 1 | 1 | 1 | 0 | 110 |
| −1 | 11 | 11 | 10 | 111 |

TABLE 2.5A

| βₖ | αₖ | Qₖ | Pₖ | Sₖ | <Pₖ₊₁> | σₖ | Pₖ₊₁ |
|---|---|---|---|---|---|---|---|
| 0 | 0 | 0 | 0 | 0 | 0 | 0 | 0 |
| 0 | 1 | −1 | 0 | −1 | 1 | 1 | 1 |
| 0 | 0 | 0 | 1 | 1 | 0 | 1 | 0 |
| 0 | 1 | −1 | 1 | 0 | 0 | 0 | 0 |
| 1 | 0 | −1 | 0 | −1 | 1 | 1 | 1 |
| 1 | 1 | −2 | 0 | −2 | 11 | 0 | −1 |
| 1 | 0 | −1 | 1 | 0 | 0 | 0 | 0 |
| 1 | 1 | −2 | 1 | −1 | 1 | 1 | 1 |

2.3. Second Bitwise Operation Algorithm

Unlike with Algorithm 2.1, let us base ourselves on the representation of Sₖ as

Sₖ=ρ^{m}ηₖ₊ₘ+ . . . +ρ^{j}ηₖ₊ⱼ+ . . . +ρηₖ₊₁+σₖ, (2.6)

where

σₖ is the k^{th} digit of the resulting code,

ηₖ₊ⱼ is the partial carry from the k^{th} digit to the (k+j)^{th},

m is the maximum number of partial carries.

Obviously, with this structure of Sₖ, the carry, Pₖ, to the k^{th} digit consists of m partial μₖⱼ carries generated in m low-order digits with numbers from (k−m) to (k−1). Thus,

Pₖ=Σⱼ₌₁^{m}μₖⱼ. (2.7)

In order for Pₖ to equal ρ-integers, the partial μₖⱼ carries must also be ρ-integers. There are no further limitations as to the numbers μₖⱼ and ηₖ₊ⱼ, so that in the general case they may differ from numbers {0,1}.

Let us name an expression of the type,

<<Sₖ>>=ηₖ₊ₘ . . . ηₖ₊ⱼ . . . ηₖ₊₁σₖ,

the resulting digit quasicode, and the expression of the type,

<<Pₖ>>=ηₖ₊ₘ . . . ηₖ₊ⱼ . . . ηₖ₊₁,

the quasicode of the carry from the kth digit.

Using the resulting relationships, we can compile the sequence of elementary operations for calculations in the k^{th} digit:

Algorithm 2.2. αₖ, βₖ, μₖⱼ are known quantities.

1. Determination of Qₖ=αₖΔβₖ.

2. Determination of Pₖ according to (2.7).

3. Determination of Sₖ according to (2.2).

4. Determination of the <<Sₖ>> quasicode.

5. Determination of σₖ from the <<Sₖ>> quasicode.

6. Determination of the <<Pₖ₊₁>> quasicode,

i.e. the partial carries from the k^{th} digit.

7. Operations 1 through 6 for the (k+1)^{th} digit are carried out.

FIG. 2.4 illustrates the computation circuit in the k-digit, and FIGS. 2.6 and 2.7 illustrate the pattern of carry distribution in Algorithm 2.2. These figures show:

N(k+j)=ηₖ₊ⱼ, M(k,j)=μₖⱼ.

Algorithm 2.2 for this bitwise operation in this coding system may have several versions due to the availability of several quasicodes for the resulting digit, Sₖ. In particular, the quasicode may coincide with the positional code if the meanings of partial carries are selected from the {0, 1} set. In a general case, the different quasicode digits acquire values from sets that differ from this one not only by their element values, but also by the cardinal number (the number of elements).

The sequence of operations in Algorithm 2.2 is used to synthesize bitwise operation tables that meet the conditions of completeness, which in this case are formulated somewhat differently:

the Pₖ carry acquires all possible values that correspond with any combination of ηₖ₊ⱼ,

any possible combination of the numbers, αₖ, βₖ, Pₖ, is present in the table.

Obviously, Algorithm 2.2 having several versions, it is possible to compile several types of tables for this bitwise operation in this coding system. Let us review some examples of synthesis of bitwise operation tables using Algorithm 2.2, and calculations using the resulting tables.

Example 2.6. Addition of codes in the system, ρ=j−1. In order to describe this operation; let us compile, using Algorithm 2.2, a short Table 2.6 containing only the value of Sₖ and the <<Sₖ>> quasicode, all digits of which acquire the value of 0 or 1. In this case the quasicode coincides with the positional code, but two of its digits always have a zero value.

Consequently, not more than six partial carries equal to 1 are generated in the k^{th} digit. This means that not more than six partial carries may enter the k^{th} digit either, i.e. 0≦Pₖ≦6. Since 0≦Qₖ≦2 on addition of these codes, then 0≦Sₖ≦8. All 8 values of Sₖ are represented in Table 2.6, and therefore it meets the condition of completeness.

To illustrate the existence of several versions of Algorithm 2.2, let us compile two more Tables, 2.6A and 2.6B, which will describe addition in this system. In these tables, the number, α, stands for the value of ‘−1’.

It follows from Table 2.6A that three partial carries may enter the k^{th} digit simultaneously (a partial carry that always equals zero is not considered here):

0≦μₖ₁≦1, 0≦μₖ₂≦1, −1≦μₖ₃≦1,

consequently, −1≦Pₖ≦3, whence −1≦Sₖ≦5. Thus Table 2.6A is complete. The completeness of Table 2.6B is proved in a similar way.

The choice of one or another version of Algorithm 2.2 is determined by the minimum number of values acquired by the Pₖ carry. From this viewpoint, Table 2.5 is not as good as Tables 2.6A and 2.6B.

Table 2.6C shows an example of addition using Table 2.6B.

TABLE 2.6

| Sₖ | >>Sₖ>> |
|---|---|
| 0 | 000000000 |
| 1 | 000000001 |
| 2 | 000001100 |
| 3 | 000001101 |
| 4 | 111010000 |
| 5 | 111010001 |
| 6 | 111011100 |
| 7 | 111011101 |
| 8 | 111000000 |

TABLE 2.6A

| Sₖ | >>Sₖ>> |
|---|---|
| −1 | 11101 |
| 0 | 00000 |
| 1 | 00001 |
| 2 | 01100 |
| 3 | 01101 |
| 4 | a0000 |
| 5 | a0001 |

TABLE 2.6B

| Sₖ | >>Sₖ>> |
|---|---|
| −3 | 10001 |
| −2 | 0aa00 |
| −1 | 01a01 |
| 0 | 00000 |
| 1 | 00001 |
| 2 | aaa00 |
| 3 | aaa01 |

TABLE 2.6C

| | | | | | | | | | | |
|---|---|---|---|---|---|---|---|---|---|---|
| Carries | 1 | 0 | 0 | 0 | | | | | | |
| | | | a | a | 0 | | | | | |
| | | | | a | a | 0 | | | | |
| | | | | | a | a | 0 | | | |
| | | | | | a | a | a | 0 | | |
| | | | | | | a | a | a | 0 | |
| Summand 1 | | | 1 | 1 | 0 | 1 | 0 | 0 | 1 | 1 |
| Summand 2 | | 1 | 1 | 1 | 0 | 0 | 1 | 0 | 1 | 1 |
| Sum | 1 | 1 | 1 | 0 | 1 | 0 | 1 | 1 | 0 | 0 |

Example 2.7. Reverse addition of codes in the ρ=j−1 system. Similarly to the preceding example, let us compile a short Table 2.7 containing only the value of Sₖ and the <<Sₖ>> quasicode, all digits of which acquire the value of 0 or 1. In this case the quasicode coincides with the positional code, but one of its digits always has a zero value. Consequently, not more than three partial carries that equal 1 are generated in the k^{th} digit. This means that not more than three partial carries may enter the k^{th} digit either, i.e. 0≦Pₖ≦3. Since −2≦Qₖ≦0 with reverse addition of these codes, then −2≦Sₖ≦3. All 6 values of Sₖ are represented in Table 2.7, and therefore it satisfies the conditions of completeness.

The part of Table 2.7 that has to do with code inversion in this system was specially marked.

Truth Table 2.7A of single-digit circuits for reverse addition of codes in this system was compiled based on Table 2.7. The part of it that is the truth table for inversion was specially marked.

FIG. 2.6 illustrates the pattern of carry distribution in single-digit circuits.

TABLE 2.7

| Sₖ | <<Sₖ>> |
|---|---|
| −2 | 11100 |
| −1 | 11101 |
| 0 | 00000 |
| 1 | 00001 |
| 2 | 01100 |
| 3 | 01101 |

TABLE 2.7A

| | |
|---|---|
| Input | <<Sₖ>> |

| | | μₖⱼ | | | | ηₖ₊ⱼ | | | |
|---|---|---|---|---|---|---|---|---|---|
| βₖ | αₖ | 4 | 3 | 2 | Sₖ | 4 | 3 | 2 | σₖ |
| 0 | 0 | 0 | 0 | 0 | 0 | 0 | 0 | 0 | 0 |
| 0 | 0 | 0 | 0 | 1 | 1 | 0 | 0 | 0 | 1 |
| 0 | 0 | 0 | 1 | 0 | 1 | 0 | 0 | 0 | 1 |
| 0 | 0 | 0 | 1 | 1 | 2 | 0 | 1 | 1 | 0 |
| 0 | 0 | 1 | 0 | 0 | 1 | 0 | 0 | 0 | 1 |
| 0 | 0 | 1 | 0 | 1 | 2 | 0 | 1 | 1 | 0 |
| 0 | 0 | 1 | 1 | 0 | 2 | 0 | 1 | 1 | 0 |
| 0 | 0 | 1 | 1 | 1 | 3 | 0 | 1 | 1 | 1 |
| 0 | 1 | 0 | 0 | 0 | −1 | 1 | 1 | 1 | 1 |
| 0 | 1 | 0 | 0 | 1 | 0 | 0 | 0 | 0 | 0 |
| 0 | 1 | 0 | 1 | 0 | 0 | 0 | 0 | 0 | 0 |
| 0 | 1 | 0 | 1 | 1 | 1 | 0 | 0 | 0 | 1 |
| 0 | 1 | 1 | 0 | 0 | 0 | 0 | 0 | 0 | 0 |
| 0 | 1 | 1 | 0 | 1 | 1 | 0 | 0 | 0 | 1 |
| 0 | 1 | 1 | 1 | 0 | 1 | 0 | 0 | 0 | 1 |
| 0 | 1 | 1 | 1 | 1 | 2 | 0 | 1 | 1 | 0 |
| 1 | 0 | 0 | 0 | 0 | −1 | 1 | 1 | 1 | 1 |
| 1 | 0 | 0 | 0 | 1 | 0 | 0 | 0 | 0 | 0 |
| 1 | 0 | 0 | 1 | 0 | 0 | 0 | 0 | 0 | 0 |
| 1 | 0 | 0 | 1 | 1 | 1 | 0 | 0 | 0 | 1 |
| 1 | 0 | 1 | 0 | 0 | 0 | 0 | 0 | 0 | 0 |
| 1 | 0 | 1 | 0 | 1 | 1 | 0 | 0 | 0 | 1 |
| 1 | 0 | 1 | 1 | 0 | 1 | 0 | 0 | 0 | 1 |
| 1 | 0 | 1 | 1 | 1 | 2 | 0 | 1 | 1 | 0 |
| 1 | 1 | 0 | 0 | 0 | −2 | 1 | 1 | 1 | 0 |
| 1 | 1 | 0 | 0 | 1 | −1 | 1 | 1 | 1 | 1 |
| 1 | 1 | 0 | 1 | 0 | −1 | 1 | 1 | 1 | 1 |
| 1 | 1 | 0 | 1 | 1 | 0 | 0 | 0 | 0 | 0 |
| 1 | 1 | 1 | 0 | 0 | −1 | 1 | 1 | 1 | 1 |
| 1 | 1 | 1 | 0 | 1 | 0 | 0 | 0 | 0 | 0 |
| 1 | 1 | 1 | 1 | 0 | 0 | 0 | 0 | 0 | 0 |
| 1 | 1 | 1 | 1 | 1 | 1 | 0 | 0 | 0 | 1 |

Example 2.8. Reverse addition of codes in System 4. Similarly to the preceding example, let us compile an abridged Table 2.8 containing only the value of Sₖ and the <<Sₖ>> quasicode, all digits of which acqujire the value of 0 or 1. In this case the quasicode coincides with the positional code. Not more than three partial carries equal to 1 are generated in the k^{th} digit. This means that not more than three partial carries may enter the k^{th} digit either, i.e. 0≦Pₖ≦3. Since −2≦Qₖ≦0 with reverse addition of these codes, then −2≦Sₖ<3. All 6 values of Sₖ are represented in Table 2.8, and therefore it satisfies the conditions of completeness.

The part of Table 2.8 that has to do with code inversion in the system was specially marked.

Truth Table 2.8A of single-digit circuits for reverse addition of codes in this system was compiled based on Table 2.8. The part of it that is the truth table for inversion was specially marked.

FIG. 2.7 illustrates the pattern of carry distribution in single-digit circuits.

TABLE 2.8

| Sₖ | <<Sₖ>> |
|---|---|
| −2 | 11100 |
| −1 | 11101 |
| 0 | 00000 |
| 1 | 00001 |
| 2 | 01100 |
| 3 | 01101 |

TABLE 2.8A

| | |
|---|---|
| Input | <<Sₖ>> |

| | | μₖⱼ | | | | ηₖ₊ⱼ | | | |
|---|---|---|---|---|---|---|---|---|---|
| βₖ | αₖ | 3 | 2 | 1 | Sₖ | 3 | 2 | 1 | σₖ |
| 0 | 0 | 0 | 0 | 0 | 0 | 0 | 0 | 0 | 0 |
| 0 | 0 | 0 | 0 | 1 | 1 | 0 | 0 | 0 | 1 |
| 0 | 0 | 0 | 1 | 0 | 1 | 0 | 0 | 0 | 1 |
| 0 | 0 | 0 | 1 | 1 | 2 | 1 | 0 | 1 | 0 |
| 0 | 0 | 1 | 0 | 0 | 1 | 0 | 0 | 0 | 1 |
| 0 | 0 | 1 | 0 | 1 | 2 | 1 | 0 | 1 | 0 |
| 0 | 0 | 1 | 1 | 0 | 2 | 1 | 0 | 1 | 0 |
| 0 | 0 | 1 | 1 | 1 | 3 | 1 | 0 | 1 | 1 |
| 0 | 1 | 0 | 0 | 0 | −1 | 0 | 1 | 1 | 1 |
| 0 | 1 | 0 | 0 | 1 | 0 | 0 | 0 | 0 | 0 |
| 0 | 1 | 0 | 1 | 0 | 0 | 0 | 0 | 0 | 0 |
| 0 | 1 | 0 | 1 | 1 | 1 | 0 | 0 | 0 | 1 |
| 0 | 1 | 1 | 0 | 0 | 0 | 0 | 0 | 0 | 0 |
| 0 | 1 | 1 | 0 | 1 | 1 | 0 | 0 | 0 | 1 |
| 0 | 1 | 1 | 1 | 0 | 1 | 0 | 0 | 0 | 1 |
| 0 | 1 | 1 | 1 | 1 | 2 | 1 | 0 | 1 | 0 |
| 1 | 0 | 0 | 0 | 0 | −1 | 0 | 1 | 1 | 1 |
| 1 | 0 | 0 | 0 | 1 | 0 | 0 | 0 | 0 | 0 |
| 1 | 0 | 0 | 1 | 0 | 0 | 0 | 0 | 0 | 0 |
| 1 | 0 | 0 | 1 | 1 | 1 | 0 | 0 | 0 | 1 |
| 1 | 0 | 1 | 0 | 0 | 0 | 0 | 0 | 0 | 0 |
| 1 | 0 | 1 | 0 | 1 | 1 | 0 | 0 | 0 | 1 |
| 1 | 0 | 1 | 1 | 0 | 1 | 0 | 0 | 0 | 1 |
| 1 | 0 | 1 | 1 | 1 | 2 | 1 | 0 | 1 | 0 |
| 1 | 1 | 0 | 0 | 0 | −2 | 0 | 1 | 1 | 0 |
| 1 | 1 | 0 | 0 | 1 | −1 | 0 | 1 | 1 | 1 |
| 1 | 1 | 0 | 1 | 0 | −1 | 0 | 1 | 1 | 1 |
| 1 | 1 | 0 | 1 | 1 | 0 | 0 | 0 | 0 | 0 |
| 1 | 1 | 1 | 0 | 0 | −1 | 0 | 1 | 1 | 1 |
| 1 | 1 | 1 | 0 | 1 | 0 | 0 | 0 | 0 | 0 |
| 1 | 1 | 1 | 1 | 0 | 0 | 0 | 0 | 0 | 0 |
| 1 | 1 | 1 | 1 | 1 | 1 | 0 | 0 | 0 | 1 |

2.4. Coding and Decoding of Complex Numbers

An encoded complex number is represented as Z=X_{α}+jX_{β}, where X_{α}, X_{β} are real and imaginary parts of the complex number that are real (positive or negative) numbers. There are known and existing decompositions for these numbers, to the base of ρ=−2 of the (1.7) type, and positional codes to the base of ρ=−2 of the (1.8) type. In the above-mentioned coding systems, the imaginary unit may be represented as follows: represented as follows: j=μ·ω, where 1 is a real number and o) is a complex number that has a short code within this system. Thus the encoded complex number is represented as

Z=X_{α}+ω·\overline{X}_{β}, where \overline{X}_{β}=μ·X_{β}.

Table 2.9 shows these numbers as well as codes for all the coding systems described above.

TABLE 2.9

| Coding System | | | | |
|---|---|---|---|---|
| No | Basic Function and Base | μ | ω | K(ω) |
| 1 | $\begin{matrix}f ( ρ , m ) = \{ \begin{matrix}{ρ}^{m / 2} & if m - even \\ j \cdot {ρ}^{( m - 1 ) / 2} & if m - odd\end{matrix} \} \\ ρ = - 2\end{matrix} ,$ | 1 | j | 10 |
| 2.1 | $f ( ρ , m ) = {ρ}^{m} , ρ = j \sqrt{2}$ | $\frac{1}{\sqrt{2}}$ | $j \sqrt{2}$ | 10 |
| 2.2 | $f ( ρ , m ) = {ρ}^{m} , ρ = - j \sqrt{2}$ | $\frac{- 1}{\sqrt{2}}$ | $- j \sqrt{2}$ | 10 |
| 3.1 | $f ( ρ , m ) = {ρ}^{m} , ρ = ( - 1 + j )$ | 1 | j | 11 |
| 3.2 | $f ( ρ , m ) = {ρ}^{m} , ρ = ( - 1 - j )$ | −1 | −j | 11 |
| 4 | $\begin{matrix}f ( ρ , m ) = {ρ}^{m} , \\ ρ = \frac{1}{2} ( - 1 + j \sqrt{7} )\end{matrix}$ | $\frac{1}{\sqrt{7}}$ | $j \sqrt{7}$ | 10101 |

In a general case, there is

Algorithm 2.4. Coding

1. Computation of \overline{X}_{β}=μ·X_{β} within the traditional binary coding system.

2. Representation of real (positive or negative) numbers X_{α}, \overline{X}_{β} as

$$X = {\sum }_{( m )} {( {α}_{m} ( - 2 ) )}^{m} , {α}_{m} = \{ 0 , 1 \}$$

in the coding system to the base of ρ=−2 (this is a known algorithm, and it will not be described here).

3. Coding of the real numbers, X_{α}, \overline{X}_{β}, into this complex number coding system by computation using the preceding formula, where the number codes (−2)^{m} are determined beforehand (e.g. by sequential multiplication by (−2)).

4. Calculation using the formula, Z=X_{α}+ω·\overline{X}_{β}, within this complex number coding system, where the code, K(ω), is known—see Table 2.9.

In a general case, there is

Algorithm 2.5. Decoding

1. Isolation of complex codes of the real and imaginary parts, X_{α}, X_{β} from the complex number Z=X_{α}+jX_{β}.

2. Decoding of real (positive and negative) numbers, X_{α}, X_{β}, into the coding system to the base, ρ=−2, i.e. computation of the αₘ={0,1} digits for decomposition of the

$$X = {\sum }_{( m )} {( {α}_{m} ( - 2 ) )}^{m}$$

type. This computation involves sequential subtraction of the numbers, (−2)^{m}, from the decoded number. And if the next subtraction reduces the residual absolute value, then αₘ=1. Otherwise αₘ=0, the exponent m is reduced by 1, and so on.

3. Decoding of real (positive and negative) numbers X_{α}, X_{β} from the coding system to the base ρ=−2 into the traditional binary coding system (this is a known algorithm, and it will not be described here).

For some systems, these common algorithms are substantially simplified. These are reviewed next.

Algorithm 2.6. Coding in System 1

1. Representation of real (positive and negative) numbers X_{α}, X_{β} within the coding system to the base of ρ=−2 in the form of codes shown in (1.8) (this is a known algorithm, and it will not be described here).

2. Formation of the code,

K(Z)= . . . βₘαₘ . . . β₁α₁β₀α₀,β₋₁α₋₁β₋₂α₋₂ . . . (2.8)

of the complex number, Z=X_{α}+jX_{β}, which is later represented as

$$K ( Z ) = … {γ}_{m} … , where \{ \begin{matrix}{γ}_{2 m} = {α}_{m} & if m - even \\ {γ}_{2 m + 1} = {β}_{m} & if m - odd\end{matrix} \} \qquad ( 2.9 )$$

Algorithm 2.7. Decoding in System 1

1. Obtaining even and odd digits from the code (2.9) of the complex number, Z=X_{α}+jX_{β}, according to the

$$\{ \begin{matrix}{α}_{m / 2} = {γ}_{m} & if m - even \\ {β}_{( m - 1 ) / 2} = {γ}_{m} & if m - odd\end{matrix} \}$$

rule.

2. Formation out of the digits αₘ and βₘ of the codes (1.8) to the base p=−2 for numbers X_{α}, X_{β}, respectively.

3. Decoding of real (positive and negative) numbers X_{α}, X_{β} from the coding system to the base ρ=−2 into the traditional binary coding system (this is a known algorithm, and it will not be described here).

Algorithm 2.8. Coding in System 2, where ρ=j\sqrt{2}.

1. Calculation of \overline{X}_{β}=μ·X_{β}, where μ=1/\sqrt{2}. This calculation is carried out in the traditional binary coding system.

2. Representation of real (positive and negative) numbers X_{α}, \overline{X}_{β} in the coding system to the base ρ=−2 as codes (1.8) (this is a known algorithm, and it will not be described here).

3. Formation of the code (2.8) of the complex number, Z=X_{α}+jX_{β}, which is later represented in the form of the code (2.9).

Algorithm 2.9. Decoding in System 2, where ρ=j\sqrt{2}.

1. Obtaining even and odd digits from the code (2.9) of the complex number, Z=X_{α}+jX_{β}, according to the

$$\{ \begin{matrix}{α}_{m / 2} = {γ}_{m} & if m - even \\ {β}_{( m - 1 ) / 2} = {γ}_{m} & if m - odd\end{matrix} \}$$

rule.

2. Formation, from the digits αₘ and βₘ of the codes (1.8) to the base ρ=−2 for numbers X_{α}, X_{β}, respectively, where X_{β}=μ·X_{β}, and μ=1/\sqrt{2}.

3. Decoding of real (positive or negative) numbers X_{α}, X_{β} from the coding system to the base ρ=−2 into the traditional binary coding system (this is a known algorithm, and it will not be described here).

4. Calculation of X_{β}=\overline{X}_{β}\sqrt{2}. This calculation is carried out in the traditional binary coding system.

2.5. Multiplication of Complex Numbers

It is necessary to find the product of complex numbers, Z=VW, where the cofactors are decomposed as follows:

$$V = {\sum }_{k} {v}_{k} f ( ρ , k ) , W = {\sum }_{h} {w}_{h} f ( ρ , h ) .$$

The product code is determined as

$$Z = {\sum }_{h} [ {Vw}_{h} f ( ρ , h ) ] .$$

Multiplication by the basic function, ƒ(ρ, h), is equal to the h digits shift for any basic function. Since Wₕ={0,1}, the multiplication of codes within the arithmetic system is reduced to additions and shifts performed in sequence.

Let us note the differences from the traditional real numbers multiplication system:

Operations with signs are absent,

Addition is performed in the complex number codes adder,

Shifting is performed in the complex number codes shifter,

At each stage of addition and shifting, the respective operation is performed on the complex number as a whole (without identifying the real and imaginary parts).

FIG. 2.8 shows a traditional consecutive multiplication circuit, which is also applicable to the multiplication of complex numbers C=A*B. At the start of multiplication the multiplier, A, is written into the RegA register, the multiplicand, B,—into the RegB register, while a <<0>> is written into the partial product register, RegQ. At each step:

m of the RegB junior digits is analyzed; let us denote the complex value of these digits as M;

the complex code of the number, S=M*RegA+RegQ, is calculated in the Sum adder;

the complex code, S, from the Sum adder output is written through the ShiftRight-1 shifter into RegC with a shift of m digits to the right;

from RegC the code is forwarded to RegQ;

the complex code from the RegB register is written through the ShiftRight-2 shifter into RegW with a shift of m digits to the right;

from RegW the code is forwarded to RegB.

The number of m being analyzed at each step of the digits determines the multiplication performance speed and the adder's complexity. For instance, in systems 1 and 2, where m=2, the number, M={1,0,−1,−2}, and the adder must perform the addition, subtraction and the subtraction of a doubled number.

For complex code C=A*B multiplication, in addition to the consecutive circuit reviewed above, a matrix-based multiplication circuit can be used—see FIG. 2.9. This circuit contains RegA, RegB and RegC registers as well as an MM matrix multiplier that consists of a multitude of adders, Add(K). The first inputs of all adders are connected to the RegA register output. The RegB register's K-digit output is connected to the controlling input of each Add(K) adder. The output of each adder (except for Add(N)) is connected to the input of the following adder with a shift by 1 digit. The output of the Add(N) adder is connected to the input of the RegC register.

At the start of multiplication, the multiplier, A, is written into the RegA register, while the multiplicand, B,—into the RegB register. If the K-digit of the RegB register equals <<1>>, then the Add(K) adder adds the complex code, A, to the preceding adder's output code shifted by 1 digit. If the K-digit of the RegB register equals <<0>>, then the Add(K) adder transmits further the output code of the preceding adder shifted by 1 digit. Thus formed at the input of the Add(N) adder is the complex code of the result, which is written into the RegC register.

3. Division and Computation of Elementary Functions of a Complex Variable

3.1. “Digit by Digit” Method

Computation of elementary functions is performed using the “digit by digit” method. As demonstrated below, it can be generalized to complex number codes.

Suppose that Z is a random complex number. Let us consider the sequence of complex numbers, Zₕ (h=1, . . . m):

Z₁, Z₂, Z₃, . . . Zₕ, Zₕ₊₁, . . . Zₘ,

and the sequence of complex codes, K(Z−Zₕ):

K(Z−Z₁), K(Z−Z₂), . . . K(Z−Zₕ), . . . K(Z−Zₘ).

Let us suppose that the complex number code has a certain characteristic, further referred to as code size. We shall express this code characteristic of the complex number, Z, by the symbol, NK(Z). The highest significant digit number or the modulus of the encoded number can be used as code size.

Let us consider the sequence of sizes, NK(Z−Zₕ):

NK(Z−Z₁), NK(Z−Z₂), . . . NK(Z−Zₕ), . . . NK(Z−Zₘ)

We will refer to the numbers sequence, Zₕ, as the generating sequence, {Zₕ}, if with a random h=1, . . . , m the following condition is satisfied:

NK(Z−Zₕ₊₁)≦NK(Z−Zₕ) 3.1)

The numbers Zₕ are formed in such a manner as to satisfy the recurrent condition:

Zₕ₊₁=Φ[Zₕ,εₕ₊₁,ρ^{h+1}] 3.2)

where aₕ=0, 1, 2, . . . ; ρ is the basis of the encoding system. The expression, ρ^{h}, will be further used to express the basic function, ƒ(ρ, h), which (as shown above) does not always equal the value of ρ^{h}.

Considering 3-1) and 3-2) simultaneously, we find that:

NK[Z−Φ(Zₕ,εₕ₊₁,ρ^{h+1})]≦NK[Z−Zₕ]. 3.3)

Let us denote:

NK(Z−Zₘ)=H(m). 3.4)

3.2. Decomposition

Let us proceed to describing the Zₘ calculation algorithm, for which purpose we have first to consider the transition process from Zₕ to Zₕ₊₁. The h generator of Zₕ is known. In order to determine the (h+1) generator of Zₕ₊₁ we must find the maximum value, aₕ₊₁, at which Zₕ₊₁ calculated using formula 3-2) will still satisfy condition 3-1). Obviously, Zₕ₊₁⁽⁰⁾=Zₕ satisfies this condition if aₕ₊₁=0, where aₕ₊₁=1. The value, \overline{Z}ₕ₊₁⁽¹⁾=Φ[Zₕ, 1, ρ^{h+1}], should be tested to see if it satisfies condition 3-1). The test consists in comparing the code values of numbers (Z−Zₕ) and (Z−\overline{Z}ₕ₊₁⁽¹⁾). There are three possible options in this comparison:

a) NK[Z−\overline{Z}ₕ₊₁⁽¹⁾]<NK[Z−Zₕ]—this inequality indicates that aₕ₊₁=1 and Zₕ₊₁=Zₕ₊₁⁽¹⁾;

b) NK[Z−\overline{Z}ₕ₊₁⁽¹⁾]>NK[Z−Zₕ]—this inequality indicates that aₕ₊₁=0 and Zₕ₊₁=Zₕ;

c) NK[Z−\overline{Z}ₕ₊₁⁽¹⁾]=NK[Z−Zₕ]—this inequality indicates that αₕ₊₁≧1 and values \overline{Z}ₕ₊₁⁽²⁾=Φ[Zₕ,2,ρ^{h+1}] or \overline{Z}ₕ₊₁⁽²⁾=Φ[Zₕ₊₁⁽¹⁾1,ρ^{h+1}] should be tested for satisfying condition 3-1). This test is carried out in a similar way by comparing the codes of numbers (Z−Zₕ₊₁⁽¹⁾) and (Z−Zₕ₊₁⁽²⁾). The test results either in the determination of the values of aₕ₊₁=1 or aₕ₊₁=2 and Zₕ₊₁=\overline{Z}₊₁⁽¹⁾ or Zₕ₊₁=\overline{Z}ₕ₊₁⁽²⁾, or in the transition to code inquiry of numbers (Z−\overline{Z}ₕ₊₁⁽²⁾) and (Z−\overline{Z}ₕ₊₁⁽³⁾), where \overline{Z}ₕ₊₁⁽³⁾=Φ[Zₕ₊₁⁽²⁾,1,ρ^{h+1}].

Consequently, as a result of the consistent use of testing with respect to code values of (Z−\overline{Z}ₕ₊₁^{(μ-1)}) and (Z−\overline{Z}ₕ₊₁^{(μ)}), where μ=0, 1, 2, . . . aₕ₊₁, the value, Zₕ₊₁=\overline{Z}ₕ₊₁^{(a}^{ₕ₊₁}⁾, is determined based on the known value Zₕ. Obviously, the calculation process of the (h+1) generator by the known h generator may be initiated from the first Z₁ generator and finished with the m^{th} generator of Zₘ. The algorithm describing the h^{th} calculation cycle of Zₘ looks like this:

Algorithm 3.1

The previous generator \overline{Z}ₕ^{(μ)}=Zₚᵣₑᵥ (μ=0, 1, 2, . . . ) and the difference Eₚᵣₑᵥ=Z−Zₚᵣₑᵥ are known.

1. The next expected generator, \overline{Z}ₕ^{(μ+1)}=Zₙₑₓₜ, is determined using the formula

Zₙₑₓₜ=Φ[Zₚᵣₑᵥ,1,ρ^{h+1}] 3.5)

2. Calculate the difference, Eₙₑₓₜ=Z−Zₙₑₓₜ.

3. Compare values Hₚᵣₑᵥ=NK(Eₚᵣₑᵥ) and Hₙₑₓₜ=NK(Eₙₑₓₜ). Then, according to the comparison results of Hₚᵣₑᵥ and Hₙₑₓₜ:

4. Determine the number of the next cycle h′.

5. Determine the value of the previous generator, Zₚᵣₑᵥ′, for the next cycle.

6. Determine the difference Z−Zₚᵣₑᵥ′ for the next cycle. The last three items are to be carried out according to Table 3.1.

7. Examine the fulfillment of the condition, Hₙₑₓₜ=H(m): if this equality is satisfied, it indicates that the m^{th} generator has been found for Zₘ, i.e. the calculation is finished; if it is not satisfied, then the h′ calculation cycle is carried out.

TABLE 3.1

| Result of comparison | h′ | Z′ₚᵣₑᵥ | Z − Z′ₚᵣₑᵥ |
|---|---|---|---|
| Hₙₑₓₜ < Hₚᵣₑᵥ | h + 1 | Zₙₑₓₜ | Z − Zₙₑₓₜ |
| Hₙₑₓₜ = Hₚᵣₑᵥ | h | Zₙₑₓₜ | Z − Zₙₑₓₜ |
| Hₙₑₓₜ > Hₚᵣₑᵥ | h + 1 | Zₚᵣₑᵥ | Z − Zₚᵣₑᵥ |

It should be rioted that several cycles may have the same number (where aₕ₊₁>1) so that the number of cycles Ω may exceed the number of generators m.

Thus the generating sequence {Zₕ} is calculated using Algorithm 3.1. This algorithm contains only the basic computer operations of addition, subtraction and value comparisons, so that it is easily implemented in an arithmetic device. The sequence of basic operations of Algorithm 3.1 is more clearly described in FIG. 3.1

Henceforth we will refer to the calculation of a generating sequence as decompositing, i.e. presentation of a complex number as the sum or product of other known numbers, which are elements of decomposition. We will refer to such representation as decomposition. Each potential element of decomposition may be absent in a specific decomposition or be present in it, recurring aₕ times. The sequence of numbers aₕ is a result of decompositing. Table 3.2 lists types of decompositing used below, and their general properties.

TABLE 3.2

| # | Designation | Decomposition | Zo | Enext = | Eo |
|---|---|---|---|---|---|
| D1 | DecompDivis | Decomposition for Division | 0 | Eprev − ρ^{-h} | Z |
| | | Z = Σaₕρ^{-h} | | | |
| D2 | DecompLogar | Decomposition to sum of Logathm | 0 | Eprev − ln(1 + ρ^{-h}) | Z |
| | | Z = Σaₕln(1 + ρ^{-h}) | | | |
| D3 | DecompBinom | Decomposition to product of Binomial | 1 | Eprev − (Z − Eprev)ρ^{-h} | Z − 1 |
| | | Z = Π(1 + ρ^{-h})^{a}_{^{h}} | | | |
| D4 | DecompBinom2 | Decomposition to product of Binomial | 1 | Z − (Z − Eprev)(1 + ρ^{-h})² | Z − 1 |
| | | in power 2: | | | |
| | | Z = Π(1 + ρ^{-h})^{2·a}_{^{h}} | | | |

3.3 Compositing

As stated earlier, the result of decompositing is the αₕ sequence of numbers. Obviously, it is possible to restore the number that was decomposited from this sequence. We are going to refer to this calculation as compositing. This operation is the opposite of decompositing and consists in calculating a complex number as a sum or product of certain other known numbers that are elements of decomposition. In this context such representation of a number will be called composition. It should also be noted that in the process of composition the elements of decomposition may be converted or substituted by other elements. That is the essence of composition and we will use this method later on.

Table 3.3 shows types of composition. Every potential element of decomposition may be absent in a particular decomposition or be present in it recurring αₕ times.

TABLE 3.3

| Number | Designation | Composition | Formula |
|---|---|---|---|
| C1 | CompDivis | Composition for Division | W = Σaₕρ^{-h} |
| C2 | CompBinom | Composition of Binomial | W = Π(1 + ρ^{-h})^{a}^{ₕ} |
| C2A | CompBinomA | Composition of Binomial (A - given | W = A · Π(1 + ρ^{-h})^{a}^{ₕ} |
| | | complex number) | |
| C3 | CompLogar | Composition for Logathm | W = Σaₕln(1 + ρ^{-h}) |
| C4 | CompLogarAngle | Composition for Complex Number | W = −j · ImΣaₕ[ln(1 + ρ^{-h})] |
| | | Argument | |
| C5 | CompLogarModul | Composition for Logathm of Modules | W = ReΣaₕ[ln(1 + ρ^{-h})] |
| C7 | CompBinomConjug | Composition for Conjugated Number | W = Π(1 + \tilde{ρ}^{-h})^{a}^{ₕ} |
| | | Square-rooting | |
| C8 | CompBinomModul | Composition for Modules | W = Π[(1 + ρ^{-h})(1 + \tilde{ρ}^{-h})]^{a}^{ₕ} |
| C9 | CompBinom2 | Composition for Binomial in power 2 | W = Π(1 + ρ^{-h})^{2a}^{ₕ} |

TABLE 3.4

| | | Decompo- | |
|---|---|---|---|
| Section | Operation | sition | Composition |
| 3.5.9 | Computation of Complex Number Modulus \|Z\| = Π(1 + ρ^{-h})(1 + \tilde{ρ}^{-h}) | D4 | C8 |
| 3.5.6 | Complex Number Square-rooting \sqrt{Z} = Π(1 + ρ^{-h}) | D4 | C2 |
| 3.5.8 | Conjugated Number Square-rooting \sqrt{\tilde{Z}} = Π(1 + \tilde{ρ}^{-h}) | D4 | C7 |
| 3.5.10 | Complex Number Exponentiation e^{Z} = Π(1 + ρ^{-h}) | D2 | C2 |
| 3.5.2 | Determination of the Natural Logarithm of a Complex Number (Option 1) | D3 | C3 |
| | ln(Z) = Σln(1 + ρ^{-h}) | | |
| 3.5.3 | Determination of the Natural Logarithm of a Complex Number (Option 2) | D4 | C3 |
| | ln(Z) = 2 · Σln(1 + ρ^{-h}) | | |
| 3.5.5 | Computation of Complex Number Argument (Option 1) | D3 | C4 |
| | arg(Z) = −j · ImΣln(1 + ρ^{-h}) | | |
| 3.5.7 | Computation of Complex Number Argument (Option 2) | D4 | C4 |
| | arg(Z) = −2j · ImΣln(1 + ρ^{-h}) | | |
| 3.5.4 | Computation of Complex Number Modulus Logarithm | D3 | C5 |
| | ln\|Z\| = ReΣln(1 + ρ^{-h}) | | |
| 3.5.1 | Division of Complex Numbers 1/Z = Σ(ρ^{-h}) | D1 | C1 |
| 3.5.11 | Transformation of Polar Coordinates into Rectangular Ones | D2 | C2A |
| | Z = \|Z\| · e^{jφ} = \|Z\| · Π(1 + ρ^{-h}) | | |
| 3.5.12 | Transition of Polar Coordinates to Rectangular Ones | D4 | C4 |
| | arg(Z) = −2j · Im(Σln(1 + ρ^{-h})), \|Z\| = Π(1 + ρ^{-h})(1 + \tilde{ρ}^{-h}) | | C8 |

3.4. Two-Step Operations

Let us now consider a certain function, W=ƒ(Z). If the generating sequence {Zₕ} for the number Z is known, then the generating sequence {Wₕ} of the number W can be calculated, since Wₕ=η(Zₕ). Specifically, the previous generator, Wₚᵣₑᵥ=η(Zₚᵣₑᵥ), and the next generator, Wₙₑₓₜ=ƒ(Zₙₑₓₜ), or taking into account the formula, 3.5),

Wₙₑₓₜ=ƒ{Φ[Zₚᵣₑᵥ,1,ρ^{h+1}]} 3.6)

It is often possible to represent the expression, 3.6), as follows:

Wₙₑₓₜ=Ψ[Wₚᵣₑᵥ,1,ρ^{h+1}] 3.7)

The computation of basic functions W=ƒ(Z) in this manner consists of two steps: decomposition of the number, Z, and composition of the number, W. These functions are listed in Table 3.4. The same information is represented differently in Table 3.5. Further, the operations described in these tables will be reviewed in more detail. Two-step operations for complex numbers represented in the floating-point form will be reviewed at the same time, specifically in the form of

Z=(−2)^{k}·M 3.8)

where M is the mantissa, a complex number code, k is the order, a real number code to the base of (−2).

TABLE 3.5

| | D1 | D2 | D3 | D4 |
|---|---|---|---|---|
| C1 | Division | | | |
| C2 | | Exponentiation | Identically | Square-rooting |
| C3 | | Identically | Logarithm | |
| C4 | | | Argument | |
| C5 | | | Modulus Logarithm | |
| C7 | | | | Conjugated |
| | | | | Square-rooting |
| C8 | | | | Modulus |
| C9 | | | | Identically |

3.5. Computational Algorithms

3.5.1. Division of Complex Numbers

Division of complex numbers

$$V = \frac{Y}{Z}$$

consists of two operations:

1. Determination of the

$$W = \frac{1}{M}$$

complex number; henceforth we will refer to this operation as inversion of the complex number, M;

2. Multiplication V=(−2)^{-k}Y·W.

The inversion algorithm of the complex number, M, involves the following:

3. Decompositing using the 1=Σaₕyₕρ^{h} formula, where

$${y}_{h} = {\sum }_{k = 0}^{k = h - 1} {a}_{k} {y}_{k} {ρ}^{k}$$

and y₀=M (“DecompDivis”).

4. Compositing using the W=Σaₕρ^{h} formula (“CompDivis”).

3.5.2. Determination of the Natural Logarithm of a Complex Number (Option 1).

The algorithm of determination of the natural logarithm of a complex number is as follows:

1. Decompositing using the M=Π(1+ρ^{-h})^{α}^{ₕ} formula (“DecompBinom”).

2. Compositing using the ln(M)=w=Σaₕln(1+ρ^{h}) formula (“CompLogar”).

3. Computation of ln(Z)=[k·ln(−2)+ln(M)]. Here

$$ln ( - 2 ) = ln ( - 1 ) + ln ( 2 ) or ln ( - 2 ) = j π + ln ( 2 ) Thus \\ ln ( Z ) = k \cdot ln ( 2 ) + w + k j π = Re Z + Im Z , where \\ Re Z = k \cdot ln ( 2 ) + Re w , Im Z = k j π + Im w . \qquad 3.9 )$$

4. Determination of the natural logarithm's principal value. Its imaginary part is within the −π≦IMZ≦π range, therefore the imaginary part of the principal value is determined by the formula:

$$g = int [ \frac{Im Z}{2 π} ] , {( Im Z )}_{main} = \{ \begin{matrix}g & if g \leq π , \\ g - 2 π & if g > π .\end{matrix} \} . \qquad 3.10 )$$

5. Result normalization.

3.5.3. Determination of the Natural Logarithm of a Complex Number (Option 2).

The algorithm of determination of the natural logarithm of a complex number is as follows:

1. Decompositing using the M=Π(1+ρ^{-h})^{2·α}^{ₕ} formula (“DecompBinom2”).

2. Compositing using the ln(M)=w=2·Σaₕln(1+ρ^{h}) formula (“CompLogar”).

Then proceed with items 3-5 of the algorithm in Section 3.5.2.

3.5.4. Computation of Complex Number Modulus Logarithm

Computation of the algorithm of the complex number modulus differs from the algorithm of taking the log in Section 3.5.2 only in that instead of the “CompLogar” composition, “CompLogarModul” is used:

W=ReΣaₕ[ln(1+ρ^{-h})]

3.5.5. Computation of Complex Number Argument (Option 1)

The computation algorithm of the complex number argument differs from the algorithm of log taking in Section 3.5.2 only in that instead of the “CompLogar” composition, “CompLogarAngle” is used:

W=−j·ImΣaₕ[ln(1+ρ^{-h})]

3.5.6. Complex Number Square-Rooting

The complex number square-rooting algorithm is as follows:

1. Reduction of the given number to

Z=(−2)^{2m}·d·M

if k—even, then 2m=k, d=1, b=0

if k—odd, then 2m=k−1, d=−2, b=1 3.11)

2. Decompositing using the M=Π(1+ρ^{-h})^{2·α}^{ₕ} formula (“DecompBinom2”).

3. Compositing using the ln(M)=W=\sqrt{d}Π(1+ρ^{-h})^{α}^{ₕ} formula (“CompBinomA”).

4. Result formation \sqrt{Z}=(−2)^{m}ln(M).

5. Result normalization.

3.5.7. Computation of Complex Number Argument (Option 2)

The computation algorithm of the complex number argument is as follows:

1. Reduction of the given number to the form shown in 3.11).

2. Decompositing using the M=π(1+ρ^{-h})^{2·α}^{ₕ} formula (“DecompBinom2”).

3. Compositing using the ln(M)=W=−2j·ImΣaₕ[ln(1+ρ^{-h})] formula (“CompLogarAngle”).

4. Computation of arg(Z)=In(ln(Z))=Im[(k+b)·ln(−2)+ln(M)]. taking into account item 3.9), we obtain arg(Z)=ln(M)+(k+b)jπ.

5. Determination of the principal value of the argument according to 3.10).

6. Result normalization.

3.5.8. Conjugated Number Square-Rooting

Conjugated complex number square-rooting algorithm differs from the complex number square-rooting algorithm only in that instead of the “CompBinom” composition, “CompBinomConjug” is used:

W=π[(1+\tilde{ρ}^{-h})^{α}^{ₕ}

3.5.9. Computation of Complex Number Modulus

The complex number modulus computation algorithm differs from the complex number square-rooting algorithm only in that instead of the “CompBinomModul” composition, “CompBinom” is used:

W=Π[(1+ρ^{-h})(1+\tilde{ρ}^{-h})]^{a}^{ₕ}

3.5.10. Complex Number Exponentiation

The task of complex number exponentiation involves determination of the Z=e^{X} number in a complex power, X=(−2)^{p}m, where m is the mantissa and p is the order. Bearing in mind 3.9), convert this number X:

$$\begin{matrix}X = Re X + j Im X \\ = {x}^{′} + β ln ( - 2 ) + j Im X \\ = {x}^{′} + β ln ( - 2 ) + j ( {x}^{″} + μ \frac{π}{2} ) \\ = {x}^{′} + β ln ( 2 ) + j β π + j ( {x}^{″} + μ \frac{π}{2} ) \\ = β ln ( 2 ) + j \frac{π}{2} ( 2 β + μ ) + ( {x}^{′} + j {x}^{″} ) .\end{matrix}$$

$$Thus Re X = β ln ( 2 ) + {x}^{′} , j Im X = j ( \frac{π}{2} ( 2 β + μ ) + {x}^{″} ) .$$

Within these relationships,

β-integer, (2β+μ) -integer, x′-fraction, x″-fraction.

It should be noted that

e^{βln(-2)=(-}2)_

And it follows that

$$\begin{matrix}exp ( X ) = exp [ ( β ln ( 2 ) + {x}^{′} ) + j ( \frac{π}{2} ( 2 β + μ ) + {x}^{″} ) ] \\ = {( - 2 )}^{β} {ⅇ}^{( {x}^{′} + j {x}^{″} )} {ⅇ}^{j \frac{π}{2} ( 2 β + μ )} \\ = {( - 2 )}^{β} {ⅇ}^{y} {ⅇ}^{j \frac{π}{2} γ} ,\end{matrix}$$

$$where y = ( {x}^{′} + j {x}^{″} ) and γ = ( 2 β + μ ) . \\ Here \begin{matrix}{( - 2 )}^{β} = \{ \begin{matrix}{2}^{β} & if β - even \\ - {2}^{β} & if β - odd\end{matrix} \} and {ⅇ}^{j \frac{π}{2} γ} \\ = ϑ \\ = \{ \begin{matrix}j & if η = 1 \\ 1 & if η = 0 \\ - j & if η = - 1 \\ - 1 & if η = - 2\end{matrix} \} ,\end{matrix}$$

where η is the residue of division of the integer γ by 4.

The exponentiation algorithm is as follows:

1. We are given the number, X=(−2)^{p}m, where m is the mantissa and p is the order.

2. If X=0, then Z=1.

3. Computation of

$${X}^{′} = \frac{Re X}{ln ( 2 )} , {X}^{″} = \frac{Im X}{π / 2} .$$

4. Extraction of integers β, γ and fractions x′, x″ from numbers X′, X″, respectively.

5. y=(x′+jx″) number decompositing using the y=Σaₕln(1+ρ^{h}) formula (“DecompLogar”).

6. Compositing using the W=Π(1+ρ^{-h})^{a}^{ₕ} formula (“CompBinom”).

7. Determination of exp(X)=(−2)^{β}·θ·W

8. Result normalization.

3.5.11. Transformation of Polar Coordinates into Rectangular Ones

Transformation of polar coordinates into rectangular ones involves computation using the Z=|Z|·e^{jφ}=|Z|·Π(1+ρ^{-h}) formula, where (|Z|, φ are polar coordinates, real numbers. The algorithm of this transformation differs from the algorithm of complex number exponentiation shown in section 3.5.10 only in that instead of the “CompBinom” composition, “CompBinomA” is used:

W=|Z|·Π(1+ρ^{-h})^{a}^{ₕ}

3.5.12. Transition of Polar Coordinates to Rectangular Ones

Transformation of polar coordinates into rectangular ones is equivalent to complex number argument and modulus computation. The corresponding algorithm is as follows:

1. Reduction of the given number to the form shown in 3.11).

2. Decompositing using the M=Π(1+ρ^{-h})^{2·a}^{ₕ} formula (“DecompBinom2”).

3. Compositing using the Wₐ=−2j·ImΣaₕ[ln(1+ρ^{-h})] formula (“CompLogarAngle”).

4. Compositing using the Wₘ=\sqrt{|a|}Π(1+ρ^{-h})(1+\tilde{ρ}^{-h})]^{a}^{ₕ} formula (“CompBinomModul”).

5. Result formation in the form of |Z|=2^{m}Wₘ.

6. Computation of arg(Z)=Im(ln(Z))=Im[k·ln(−2)+ln(M)]. Bearing in mind 3.9), we determine arg(Z)=In(ln(M))+kjπ.

7. Determination of the main argument value according to 3.10).

8. Result normalization.

4. Processor Design

The processor has a traditional structure. The differences are in the data representation, in the structure of the microprogrammed operation control unit of the arithmetic device, and in the design of some operational units of the arithmetic device.

4.1. Data Representation

Complex numbers are represented in the floating point form, specifically as

Z=(−2)^{k}·M,

where

M is the mantissa, a complex number,

k is the order, a real (positive or negative) number.

The complex number, M, is represented by code in one of the 4 numerical systems mentioned above. This code has double the digit capacity of the traditional real number code with this relative coding accuracy.

The order, k, is represented by a real number code to the base of (−2).

4.2. Microprogrammed Control Unit

The microprogrammed control unit of the arithmetic device performs the above operations—arithmetic, encoding, decoding and computation of elementary functions. During the microprogram execution, different operational units of the arithmetic device are addressed. Common operational units (such as the multiplexer, register, shifter, etc.) and specialized ones needed for operations with complex number codes are identified among them. The latter are described below.

4.3. Operational Units

4.3.1. Comparison Unit of Low-digit Complex Codes by the Modulus

This unit compares two G-digit complex codes by the modulus. Before this unit is built, a modulus table (Table 4.1) is compiled for it. This table lists all G-digit αₖ combinations and the code modulus, Mᵢ, represented by each i combination. The Mᵢ modulus is calculated using the formula,

$${M}_{i} = {\sum }_{k = 0}^{G - 1} {α}_{k} f ( ρ , k )$$

Next, the product of two such tables is found and as a result the unit truth table (Table 4.2) is compiled. This table lists all G combination pairs of αₖ digits of the first code and βₖ digits of the second code. Moduli Mᵢ′ and Mₘ″ are designated for each respective pair, as well as the comparison result of these moduli—the C code. Thus the table describes the function, C=ψ({αₖ},{βₖ}). The unit fulfills this table—see FIG. 4.1, where:

Alfa is the input G of αₖ digits,

Beta is the input G of βₖ digits,

C is the resulting function.

TABLE 4.1

| Line | Module | α_{G-1} | α_{G-2} | . . . | αₖ | . . . | α₁ | α₀ |
|---|---|---|---|---|---|---|---|---|
| 0 | | | | | | | | |
| 1 | | | | | | | | |
| . . . | | | | | | | | |
| I | Mᵢ | | | | | | | |
| . . . | | | | | | | | |
| 2^{G} − 1 | | | | | | | | |

TABLE 4.2

| Compare | Modules | | β_{N-1} | . . . | β₀ | α_{N-1} | . . . | α₀ |
|---|---|---|---|---|---|---|---|---|
| C | M″ₘ | M′ᵢ | | | | | | |

4.3.2. Unequal High-Order Digit Number Comparison Unit

This unit makes the unequal high-order digit number (UHDN) value comparison. FIG. 4.2 shows an interconnection diagram of single-digit units with one another and with code registers A and B being compared. The truth table (Table 4.3) describes the operation of the single-digit unit using the following designations:

C(k)—k-digit unit,

A(k),B(k)—k-digits of codes being compared,

V1, V2—input carries,

W1, W2—output carries.

Carry codes (W2, W1) are interpreted as follows:

00—codes are compared by the UHDN,

01—A>B by the UHDN,

10—A<B by the UHDN.

TABLE 4.3

| A | B | V2 | V1 | W1 | W2 |
|---|---|---|---|---|---|
| 0 | 0 | 0 | 0 | 0 | 0 |
| 0 | 1 | 0 | 0 | 1 | 0 |
| 1 | 0 | 0 | 0 | 0 | 1 |
| 1 | 1 | 0 | 0 | 0 | 0 |
| 0 | 0 | 0 | 1 | 0 | 1 |
| 0 | 1 | 0 | 1 | 1 | 0 |
| 1 | 0 | 0 | 1 | 0 | 1 |
| 1 | 1 | 0 | 1 | 0 | 1 |
| 0 | 0 | 1 | 0 | 1 | 0 |
| 0 | 1 | 1 | 0 | 1 | 0 |
| 1 | 0 | 1 | 0 | 0 | 1 |
| 1 | 1 | 1 | 0 | 1 | 0 |

4.3.3. Comparison Unit of Multidigit Complex Codes by the Modulus

This unit is shown in FIG. 4.3. The codes being compared are connected to the UHIDN comparison unit, which is described above in Section 4.3.2. At its output, the unequal high-order digit number (URN) is generated, which equals N. This number is the keying signal for the multiplexer and opens its N-input. Two groups of code digits being compared, same-name by G and aligned in succession, are connected to each of these inputs. The high-order digit number in the group equals N. Thus two groups of high-order digits of the compared codes arc generated at the multiplexer's output. They are fed into the comparator input of two G-digit code moduli. The latter is described above in Section 4.3.1

4.3.4. Algebraic Adder of M-Codes

The algebraic adder is described in FIG. 4.4, where

Inverter1—the first doubler inverter,

Inverter2—the second doubler inverter,

Adder—the inverse adder,

A—the n-digit input of the first summand,

B—the n-digit input of the second summand,

C—the n-digit adder output,

q₁, q₂—inversion codes of doubler inverters In1 and In2.

Algebraic adder functions as follows. The summand code is converted in the doubler inverters using the formula, \overline{A}=q·A, q=−1, 0, 1. The converted summands are added in the adders using the formula, C=−\overline{A}−\overline{B}. Thus the algebraic adder calculates C=(−q₁·A−q₂·B).

Inverter and inverse adder designs for all complex number encoding systems are described above.

### DESCRIPTION OF PREFERRED EMBODIMENT

In the following description, numerous specific details are set forth to provide a thorough understanding of the invention. However, well-known circuits, structures and techniques have not been shown in detail in order not to obscure the invention.

According to one aspect of the invention, a method and apparatus for representing and storing complex number data under coding systems which allow efficient arithmetic operations to be performed and for performing such is described. In one embodiment of the invention, complex number data is coded in a manner which allows the data to be stored and manipulated using one data element for both the real and imaginary parts of the complex number rather than two separate data elements.

According to another aspect of the invention, a data processing system generally having a CPU, DRAM, a bus, a PCI bridge, and a complex number coprocessor is described. According to another aspect of the invention, the complex number coprocessor component of the data processing system has stored therein data representing sequences of instructions which, when combined with certain unique circuitry also contained therein and executed, cause the coprocessor to perform the above described method and to perform complex number arithmetic operations. The term data processing system is used herein to refer to any machine for processing data, including the computer system(s) described herein.

Referring to FIG. 1, there is shown a block diagram of an exemplary data processing system 10 according to one embodiment of the invention. The data processing system 10 includes a central processing unit or CPU 20, a storage device such as dynamic random access memory or DRAM 30, a CPU bus 40, a PCI bridge 50, and a complex number coprocessor 60. The coprocessor includes a control unit 70 and an arithmetic unit 80. The CPU 20, DRAM, and coprocessor 60 are coupled by the PCI bridge 50. In addition, a number of user input/output devices, such as a keyboard and a display, may also be coupled to the bus 40. The CPU 20 represents a central processing unit of any type of architecture, such as a CISC, RISC, VLIW, or hybrid architecture. In addition, the CPU 20 could be implemented on one or more chips or circuit boards. The DRAM 30 represents only one or several possible mechanisms for storing data. Other possible storage devices may include read only memory (ROM), random access memory (RAM), magnetic disk storage mediums, optical storage mediums, flash memory devices, and/or other machine-readable mediums. The bus 40 represents one or more busses (e.g., PCI, ISA, X-Bus, EISA, VESA, etc.) and bridges (also termed as bus controllers). While this embodiment is described in relation to CPU and coprocessor computer system (i.e. a multiprocessor computer system), the invention could be implemented in a single processor computer system. In addition, while this embodiment is described in relation to a 64-bit computer system, the invention is not limited to a 64-bit computer system. Of course, the coprocessor 60 contains additional circuitry not shown, which is not essential for understanding the invention.

Referring to FIG. 2, there is shown a block diagram of the arithmetic unit 80 of the exemplary complex number coprocessor 60. The arithmetic unit has a control unit 90, an arithmetic unit for mantissas 100, an arithmetic unit for exponents 110, read-only memory or ROM 120, mantissa registers 130, exponent registers 140, an internal bus 150, bus interface registers 160, accumulators 170, encoders 180, decoders 190, and an exponent to mantissa mover 200. The registers 130 and 140 contain information including control/status data, integer data, floating point data, and complex number data stored in one or more of the codes described herein. The ROM 120 contains the software instructions necessary for performing any and/or all of the method steps described herein.

Of course, the ROM 120 preferably contains additional software, which may be associated with various arithmetic operations, which is not necessary for understanding the invention. The software contained in ROM 120 is executed by the any and/or all of the control unit 90, mantissa unit 100, and exponent unit 110. The control unit 90, encoders 180, decoders 190, accumulators 170, exponent to mantissa mover 200, mantissa unit 100, and exponent unit 110 may be implemented using any number of different mechanisms (e.g., a look-up table, a hardware implementation, a PLA, etc.). While the method and corresponding software instructions described herein may be represented by a series of if/then statements, it is understood that the execution of an instruction does not require a serial processing of these if/then statements. Rather, any mechanism for logically performing this if/then processing is considered to be within the scope of the implementation of the invention. Of course, the arithemetic unit 80 contains additional circuitry, which is not necessary for understanding the invention.

Referring to FIG. 6, there is shown the encoding method steps according to one embodiment of the invention. In response to receiving an instruction from the CPU 20, two data elements representing the real and imaginary parts of a complex number 610 are read by the coprocessor 60 from the CPU 20 and/or DRAM 30. These two elements are then used to generate a single code for the complex number which is stored as a single data element. As a result of this coding, arithmetic operations on complex numbers may be performed on a single data element which contains both real and imaginary data. This results in more efficient complex arithmetic operations.

In step 610, the complex number Z, consists of a real part Xa and an imaginary part Xb, is read by the coprocessor 60 such that Z=Xa+jXb, where Xa and Xb are real numbers (positive or negative) in base 2 and where j=(−1)\hat{ }(½). The data elements representing Xa and Xb may be stored and read from the coprocessor's 60 registers 130 and 140 during encoding and decoding method described herein.

In step 620, the value of Xb is scaled by a variable u, in base 2, such that Xb=u*Xb. The value of variable u is determined by the particular coding system that may be used. The data elements corresponding to different values of u may be stored in the coprocessor's 60 ROM 120. The various coding systems and the definition of the variable u are described later in conjunction with FIG. 12.

At step 630, the binary code of Xa is converted from base 2 to base −2 and may be represented by the symbol K(Xa) 650 such that K(Xa)= . . . a(m) . . . a(2), a(1), a(0), a(−1), a(−2) . . . , where m is the mth digit in the code, a(m)={0,1}, and Xa in base −2 is given by Xa=Sum(m) [a(m)*(−2)\hat{ }m].

At step 640, the binary code of Xb is also converted from base 2 to base −2 and may be represented by the symbol K(Xb) 660 such that K(Xb)= . . . b(m) . . . b(2), b(1), b(0), b(−1), b(−2) . . . , where m is the mth digit in the code, b(m)={0,1}, and Xb in base −2 is given by Xb=Sum(m)[b(m)*(−2)\hat{ }m].

At step 670, the binary code K(Z) 680 is composed for the complex number Z by interlaying the binary codes K(Xa) and K(Xb) such that K(Z)= . . . b(m), a(m). . . b(2), a(2), b(1), a(1), b(0), a(0), b(−1), a(−1), b(−2), a(−2) . . . or, K(Z)= . . . y(2m+1), y(2m) . . . y(m) . . . y(2), y(1), y(0), y(−1), y(−2) . . . , where y(2m)=a(m) for even m and y(2m+1)=b(m) for odd m. Note that one my write Z=Sum (2m)[y(m)*f(p,m)], where y(m)=a(m) for even m and y(m)=b(m) for odd m. The data element representing K(Z) may be stored and read from the coprocessor 's 60 registers 130 and 140 during the encoding and decoding method described herein.

FIG. 12 lists six (6) exemplary coding systems 1250, 1260, 1270, 1280, 1290, and 1300 that may be used. Each coding system is designated symbolically by the function f(p, m) 1210, where m is the mth digit in the resulting code for the complex number and where p 1210 is the coding base which has associated with it the variables u 1220 and w 1230, where u is a real number and w is a complex number such that u*w=j, where j=(−1)\hat{ }(½). The symbol K(w) 1240 represents the binary code for the variable w 1230 under the coding system f(p,m) 1210. It should be noted that coding system 1250 has a purely real base p=−2, which eliminates the need in the prior art for a separate sign data element. Coding systems 1260 and 1270 have purely imaginary bases, p=±j*2\hat{ }(½), which are complex conjugates. Coding systems 1280 and 1290 have complex bases, p=−1±j, which are also complex conjugates. And, coding system 1300 has a complex base, p=½ (−1+j7\hat{ }(½)). Thus, a coding system may be selected based on the complexity of the arithmetic operation to be performed or on the complexity of the arguments of that operation. It is understood that similar “arithmetical” coding systems are considered to be within the scope of the invention. A coding system is “arithmetical” if given the complex numbers Z1 and Z2 that may be represented in the coding system, the numbers corresponding to −Z1, −Z2, Z1+Z2, and Z1*Z2 may also be represented by the coding system.

For example, under coding system 1250 where f(p,m) 1210=p\hat{ }m/2 for even m and j*p\hat{ }(m−1)/2 for odd m, where p 1210=−2, and where u 1220=1 and w 1230=j, and where the code for w under f(p,m), represented by K(w), is K(w) 1240=10, a complex number Z=Xa+jXb=7+j4 would be coded as follows:

Z=Xa+jXb=7+j4 610

Xb=u*Xb=1*4=4 620

Xa=7=(1*(−2)\hat{ }4)+(1*(−2)\hat{ }3)+(0*(−2)\hat{ }2)+(1*(−2)\hat{ }1)+(1*(−2)\hat{ }0) 630

Xb=4=(0*(−2)\hat{ }4)+(0*(−2)\hat{ }3)+(1*(−2)\hat{ }2)+(0*(−2)\hat{ }1)+(0*(−2)\hat{ }0) 640

K(Xa)=11011 650

K(Xb)=00100 660

K(Z)=0101100101 670, 680

One may check the code K(Z) in the above example by expanding it using Z=Sum(2m) [y(m)*f(p,m)] or Z=Sum (2m)[y(m)*p\hat{ }(m/2)] for even m plus Sum(2m)[y(m)*j*p\hat{ }((m−1)/2))] for odd m. The result is as follows:

Z=[1*(−2)\hat{ }(0/2)]+[0*j*(−2)\hat{ }((1−1)/2))]+[1*(−2)\hat{ }(2/2)]+[0*j*(−2)\hat{ }((3−1)/2))]+[0*(−2)\hat{ }(4/2)]+[1*j*(−2)\hat{ }((5−1)/2))]+[1*(−2)\hat{ }(6/2)]+[0*j*(−2)\hat{ }((7−1)/2))]+[1*(−2)\hat{ }(8/2)]+[0*j*(−2)\hat{ }((9−1)/2))]

Or,

Z=[1*(−2)\hat{ }(0)]+[1*(−2)\hat{ }(1)]+[1*j*(−2)\hat{ }(2)]+[1*(−2)\hat{ }(3)]+[1*(−2)\hat{ }(4)]

Or,

Z=1−2+j4−8+16

Or,

Z=7+j4

Referring back to FIG. 6, at step 690, the desired arithmetic operation is performed on the complex number Z which has been coded as K(Z) and where Z=Xa+wXb. The instruction for a desired arithmetic operation may be read by the coprocessor 60 from the CPU 20 and/or DRAM 30.

In general, the complex number Z may be represented in floating point form as Z=(−2)\hat{ }k*M, where M is the mantissa which is a complex number having the code K(Z) and where k is the exponent which is a real (positive or negative) number.

The steps 610 through 680 may be performed on additional complex numbers where the desired arithmetic operation involves multiple arguments. For example, squaring a complex number may involve a single complex number whereas multiplication may involve two complex numbers. It is understood that all arithmetic operations are considered to be within the scope of the invention. Such arithmetic operations my include addition, subtraction, multiplication, division, comparison, logarithms, binomials, potentiating, square roots, cube roots, sine, cosine, hyperbolic functions, polar/cartesian coordinates, and fast fourier transforms. As noted above, and referring to FIG. 1 and FIG. 2, the ROM 120 preferably contains software associated with various arithmetic operations, which is not necessary for understanding the invention. The software contained in ROM 120 may be executed by any and/or all of the coprocessor 60, control unit 90, mantissa unit 100, and exponent unit 110.

Referring to FIG. 3, FIG. 4, and FIG. 5, there is shown carry-in circuitry for performing arithmetic operations on one or more complex numbers of the form Z which have been coded as K(Z), where Z=Xa+wXb, in the coprocessor 60. In general, as the complexity of the coding system increases from the simpler systems 1250, 1260, and 1270, which are based on purely real or imaginary values of p, to the more complex systems 1280, 1290, and 1300, which are based on complex values of p, the speed of processing increases as does the size (i.e. complexity) of the carry-in circuitry.

In particular, for coding systems 1250, 1260, and 1270, the carry-in circuitry 300 illustrated in FIG. 3 would be used for bitwise operations (i.e. addition, subtraction, multiplication by a constant, and inversion) associated with arithmetic operations. The carry-in 380 for the k digit 340 of two coded complex numbers A and B whose resultant is C, designated by A(k) 310, B(k) 320, and C(k) 330, respectively, is given by the carry-out 380 of the k−2 360 digit.

For coding systems 1280 and 1290, the carry-in circuitry 400 illustrated in FIG. 4 would be used for bitwise operations (i.e. addition, subtraction, multiplication by a constant, and inversion) associated with arithmetic operations. The carry-in 490 for the k digit 440 of two coded complex numbers A and B whose resultant is C, designated by A(k) 410, B(k) 420, and C(k) 430, respectively, is given by the sum of the carry-outs of the k−2 460, k−3 470, and k−4 480 digits.

For coding system 1300, the carry-in circuitry 510 illustrated in FIG. 5 would be used for bitwise operations (i.e. addition, subtraction, multiplication by a constant, and inversion) associated with arithmetic operations. The carry-in 560 for the k digit 570 of two coded complex numbers A and B whose resultant is C, designated by A(k) 520, B(k) 530, and C(k) 540, respectively, is given by the sum of the carry-outs of the k−1 580, k−2 590, and k−3 595 digits.

Referring again to FIG. 1 and FIG. 2, in order to perform arithmetic operations on one or more complex numbers of the form Z which have been coded as K(Z), where Z=Xa+wXb, the coprocessor 60 may contain specialized comparison and adder circuitry. The specialized comparison and adder circuitry is illustrated in FIG. 8, FIG. 9, FIG. 10, and FIG. 11.

FIG. 8 shows a block diagram illustrating a comparison unit for two low-digit complex data elements 810. A 820 and B 830 are data elements each consisting of G digits, and each of which have been coded as K(A)=a(G−1), a(G−2) . . . a(1), a(0) and K(B)=b(G−1), b(G−2) . . . b(1), b(0), respectively, under one of the coding systems described herein. The output of the comparison unit 810 is C 840. The comparison made by this unit is with respect to the modulus M of each input. The modulus of K(A), designated Ma, is given by Ma=Sum(k=0 to G−1)[a(k) f(p,k)] and the modulus of K(B) designated by Mb, is given by Mb=Sum(k=0 to G−1)[b(k)f(p,k)]. A table is constructed within the comparison unit 850 listing the moduli for all G combination pairs of a(k) for K(A) and b(k) for K(B). From this table a second table is constructed listing moduli for each respective pair and the corresponding comparison result C 840. Thus, C 840 may be described by the function C=f({a(k)},{b(k)})

FIG. 9 shows a block diagram illustrating a comparison unit for unequal high-order data elements 900. A 820 and B 830 are data elements. The subunits 930, 960, and 990 compare the k+1, k, and k−1 digits of A 820 and B 830, respectively. The comparison for the k digit 960 results in two carry-outs W1 970 and W2 980 which are a function of the k digit of A 820, the k digit of B 830, and the two carry-ins V1 940 and V2 950. The values for W1 970 and W2 980 are derived from a look-up table contained in each subunit 930, 960, and 990. The overall result of the comparison is N 910 which may be defined as the unequal high-order digit number.

FIG. 10 shows a block diagram illustrating a comparison unit for multi-digit complex codes by the modulus 1000. The data elements A 820 and B 830 are connected to the comparison unit for unequal high-order data elements 900. The output of 900 is N 910. N 910 is then used as a keying signal for the multiplexers 1030 and 1040 which in turn connect two groups of G digits of A 820 and B 830 to the input of the comparison unit for low-digit complex data elements 850. The overall result of the comparison is C 840.

FIG. 11 shows a block diagram illustrating an algebraic adder 1100. The inputs to the adder 1100 are n-digit complex number data elements A 1110 and B 1120 which have been coded under one of the coding systems described herein. A 1110 and B 1120 are input to the adder's 1110 double inverters 1160 and 1170, respectively. Also input to the double inverters 1160 and 1170 are the inversion codes q1 1140 and q2 1150, respectively. Each inversion code q1 1140 and q2 1150 may take on the values −1, 0, and 1. The output of each inverter 1160 and 1170 is given by A=q1*A 1190 and B=q2*B 1195, respectively. As such, the output of the adder 1180 given by C 1130 may be written as C=

A−B or C=−q1*A−q2*B. Accordingly, the operation A+B may be selected by setting q1=q2=−1; the operation A−B by setting q1=−1 and q2=1; the operation −A+B by setting q1=1 and q2=−1; the operation −A−B by setting q1=q2=1; the operation −A by setting q1=1 and q2=0; and the operation -B by setting q1=0 and q2=1.

FIG. 7 illustrates the decoding method steps 700 according to one embodiment of the invention. After completing the arithmetic operation 710 and decoding steps, two data elements representing the real and imaginary parts of the resultant complex number 800 are written by the coprocessor 60 to the CPU 20 and/or DRAM 30.

In step 720, the code for the resultant complex number Z, again represented by the symbol K(Z), is read from the registers 130 and 140. At step 730, K(Z) is given by K(Z)= . . . y(2m+1), y(2m) . . . y(m) . . . y(2), y(1), y(0), y(−1), y(−2) . . .

At step 740 the codes for the real and imaginary parts of the result Z, again represented by K(Xa) and K(Xb), respectively, and such that Z=Xa+wXb, are obtained by decomposition (de-interlaying) of K(Z) such that K(Xa) 750= . . . a(m) . . . a(2), a(1), a(0), a(−1), a(−2) . . . and K(Xb) 760= . . . b(m) . . . b(2), b(1), b(0), b(−1), b(−2) . . . , and where a(m/2)=y(m) for even m and b((m−1)/2)=y(m) for odd m.

At step 770, the binary code of Xa is converted from base −2 to base 2. At step 780, the binary code of Xb is converted from base −2 to base 2. At step 790, the value of Xb is calculated, in base 2, from the equation Xb=Xb/u. Once again, the value of u depends on the coding system used.

At step 800, the result of the arithmetic operation Z, consisting of a real part Xa and an imaginary part Xb, such that Z=Xa+jXb, where Xa and Xb are real numbers (positive or negative) in base 2 is written by the coprocessor 60 to the CPU 20 and/or DRAM 30.

The embodiments of the invention in which an exclusive property or privilege is claimed are defined as follows:

1. A method of storing at least one complex number Z consisting of a real part Xa and an imaginary part Xb, each of said real part Xa and said imaginary part Xb having a separate base 2 binary code, in the memory of a complex number arithmetic processor as a single base −2 binary code K(Z), said method comprising the steps of:
a) reading said base 2 binary code for said real part Xa and said base 2 binary code for said imaginary part Xb;
b) reading a scaling factor u;
c) multiplying said imaginary part Xb by said scaling factor u to produce a scaled imaginary part Xb having a base 2 binary code;
d) converting said base 2 binary code for said real part Xa to base −2 to produce a base −2 binary code for said real part Xa;
e) converting said base 2 binary code for said scaled imaginary part Xb to base −2 to produce a base −2 binary code for said scaled imaginary part Xb;
f) composing said single base −2 binary code K(Z) by selecting alternate bits from said base −2 binary code for said real part Xa and said base −2 binary code for said scaled imaginary part Xb; and,
g) writing said single base −2 binary code K(Z) for said complex number Z to said memory of said complex number arithmetic processor.

2. The method of claim 1 wherein said scaling factor u is a real number.

3. A method of storing at least one complex number Z having a single base -2 binary code K(Z) and a scaling factor u, in the memory of a complex number arithmetic processor as a separate real part Xa and a separate imaginary part Xb, each of said real part Xa and said imaginary part Xb having a separate base 2 binary code, said method comprising the steps of:
a) reading said single base −2 binary code K(Z) for said complex number Z;
b) reading said scaling factor u;
c) composing a base −2 binary code for said real part Xa and a base −2 binary code for a scaled imaginary part Xb by selecting alternate bits from said single base −2 binary code K(Z);
d) converting said base −2 binary code for said real part Xa to base 2 to produce a base 2 binary code for said real part Xa;
e) converting said base −2 binary code for said scaled imaginary part Xb to base 2 to produce a base 2 binary code for said scaled imaginary part Xb;
f) dividing said scaled imaginary part Xb by said scaling factor u to produce said imaginary part Xb having a base 2 binary code; and,
g) writing said base 2 binary code for said real part Xa and said base 2 binary code for said imaginary part Xb to said memory of said complex number arithmetic processor.

4. The method of claim 3 wherein said scaling factor u is a real number.

5. A method of performing an arithmetic operation on at least one complex number in a complex number arithmetic processor, comprising the steps of:
a) reading at least one said complex number Z, each said complex number Z consisting of a real part Xa and an imaginary part Xb, each of said real part Xa and said imaginary part Xb having a separate base 2 binary code;
b) reading said arithmetic operation;
c) selecting a coding system f(p,m) having a base p, a scale factor u, and an imaginary unit w, wherein the product of said scale factor u and said imaginary unit w equals the complex unit j and wherein the complex unit j equals the square root of negative one;
d) coding each said complex number Z to produce a single base -2 binary code K(Z) defined by said coding system f(p,m);
e) coding said imaginary unit w to produce a single base −2 binary code K(w) defined by said coding system f(p,m);
f) performing said arithmetic operation using said single base −2 binary code K(Z) for each complex number Z and said single base −2 binary code K(w) for said imaginary unit w, to produce at least one resultant complex number, each said resultant complex number Z′ having a single base −2 binary code K(Z′); and,
g) decoding each said resultant complex number Z′ to produce a base 2 binary code for the real part Xa′ of each said resultant complex number Z′ and a base 2 binary code for the imaginary part Xb′ of each said resultant complex number Z′; and,
h) storing each said base 2 binary code for the real part Xa′ and each base 2 binary code for the imaginary part Xb′ of each said resultant complex number Z′.

6. The method of claim 5 wherein said coding system f(p,m)=p\hat{ }(m/₂), for even m, f(p,m)=j*p\hat{ }((m−1)/2), for odd m, wherein m is the mth digit in said binary code, wherein p=−2, wherein u=1, wherein w=j, and wherein w has a single base −2 binary code K(w)=10.

7. The method of claim 5 wherein said coding system f(p,m)=p\hat{ }m, wherein m is the mth digit in said binary code, wherein p=j*(2\hat{ }(½)), wherein u=1/((2\hat{ }(½)), wherein w=j*(2\hat{ }(½)), and wherein w has a single base −2 binary code K(w)=10.

8. The method of claim 5 wherein said coding system f(p,m)=p\hat{ }m , wherein m is the mth digit in said binary code, wherein p=−j*(2\hat{ }(½)), wherein u=−-1/((2\hat{ }(½)), wherein w=−j*(2\hat{ }(½)), and wherein w has a single base −2 binary code K(w)=10.

9. The method of claim 5 wherein said coding system f(p,m)=p\hat{ }m, wherein m is the mth digit in said binary code, wherein p=−1+j, wherein u=1, wherein w=j, and wherein w has a single base −2 binary code K(w)=11.

10. The method of claim 5 wherein said coding system f(p,m)=p\hat{ }m, wherein m is the mth digit in said binary code, wherein p=−1−j, wherein u=−1, wherein w=−j, and wherein w has a single base −2 binary code K(w)=11.

11. The method of claim 5 wherein said coding system f(p,m)=p\hat{ }m, wherein m is the mth digit in said binary code, wherein p=½*(−1+j*(7\hat{ }(½))), wherein u=1/((7\hat{ }(½)), wherein w=j*(7\hat{ }(½)), and wherein w has a single base −2 binary code K(w)=10101.

12. The method of claim 5 wherein said coding system f(p,m) is selected by default.

13. The method of claim 5 wherein said coding system f(p,m) is predetermined.

14. The method of claim 5 wherein said coding system is selected in accordance with said arithmetic operation.

15. The method of claim 5 wherein said coding system is selected in accordance with at least one said complex number.

16. The method of claim 5 wherein said arithmetic operation includes bitwise operations, wherein said bitwise operations include addition, subtraction, multiplication by a constant, and inversion.

17. The method of claim 5 wherein said arithmetic operation includes multiplication, division, comparison, logarithms, binomials, potentiating, square roots, cube roots, sine, cosine, hyperbolic functions, polar/cartesian coordinates, and fast fourier transforms.

18. The method of claim 16 wherein a carry-in for said bitwise operation on a kth digit of two coded complex numbers is given by a carry-out of a k−2th digit.

19. The method of claim 16 wherein a carry-in for said bitwise operation on a kth digit of two coded complex numbers is given by the sum of a carry-out of a k−2th digit, a carry-out of a k−3th digit, and a carry-out of a k−4th digit.

20. The method of claim 16 wherein a carry-in for said bitwise operation on a kth digit of two coded complex numbers is given by the sum of a carry-out of a k−1th digit, a carry-out of a k−2th digit, and a carry-out of a k−3th digit.

21. The method of claims 1, 3, and 5 wherein said complex number Z is represented in floating point form as Z=(−2)\hat{ }k*M, wherein M is the mantissa which is a complex number having a code K(Z), and wherein k is a real number exponent.

22. An adder circuit for adding a first complex number and a second complex number, said first and said second complex numbers being stored as single base −2 binary codes under a coding system f(p,m), said adder circuit having a plurality of stages, each said stage comprising:
a first input for receiving a kth digit of said first complex number;
a second input for receiving a kth digit of said second complex number;
a third input for receiving a kth carry-in from a carry-out of a k−2th stage;
a first output for providing a kth result digit;
a second output for providing a kth carry-out; and, an adder for adding said kth digit of said first complex number, said kth digit of said second complex number, and said kth carry-in to provide said kth result digit and said kth carry-out.

23. The adder circuit of claim 22 wherein said coding system f(p,m)=p\hat{ }(m/2), for even m, f(p,m)=j*p\hat{ }((m−1)/2), for odd m, wherein m is the mth digit in said binary code, wherein p=−2, wherein u=1, wherein w=j, and wherein w has a single base −2 binary code K(w)=10.

24. The adder circuit of claim 22 wherein said coding system f(p,m)=p\hat{ }m, wherein m is the mth digit in said binary code, wherein p=j*(2\hat{ }(½)), wherein u=1/((2\hat{ }(½)), wherein w=j*(2\hat{ }(½)), and wherein w has a single base −2 binary code K(w)=10.

25. The adder circuit of claim 22 wherein said coding system f(p,m)=p\hat{ }m, wherein m is the mth digit in said binary code, wherein p=−j*(2\hat{ }(½)), wherein u=−1/((2\hat{ }(½)), wherein w=−j*(2\hat{ }(½)), and wherein w has a single base −2 binary code K(w)=10.

26. An adder circuit for adding a first complex number and a second complex number, said first and said second complex numbers being stored as single base −2 binary codes under a coding system f(p,m), said adder circuit having a plurality of stages, each said stage comprising:
a first input for receiving a kth digit of said first complex number;
a second input for receiving a kth digit of said second complex number;
a third input for receiving a first kth carry-in from a carry-out of a k−2th stage;
a fourth input for receiving a second kth carry-in from a carry-out of a k−3th stage;
a fifth input for receiving a third kth carry-in from a carry-out of a k−4th stage;
a first output for providing a kth result digit;
a second output for providing a kth carry-out; and, an adder for adding said kth digit of said first complex number, said kth digit of said second complex number, said first kth carry-in, said second kth carry-in, and said third kth carry-in to provide said kth result digit and said kth carry-out.

27. The adder circuit of claim 26 wherein said coding system f(p,m)=p\hat{ }m, wherein m is the mth digit in said binary code, wherein p=−1+j, wherein u=1, wherein w=j, and wherein w has a single base −2 binary code K(w)=11.

28. The adder circuit of claim 26 wherein said coding system f(p,m)=p\hat{ }m, wherein m is the mth digit in said binary code, wherein p=−1−j, wherein u=−1, wherein w=−j, and wherein w has a single base −2 binary code K(w)=11.

29. An adder circuit for adding a first complex number and a second complex number, said first and said second complex numbers being stored as single base −2 binary codes under a coding system f(p,m), said adder circuit having a plurality of stages, each said stage comprising:
a first input for receiving a kth digit of said first complex number;
a second input for receiving a kth digit of said second complex number;
a third input for receiving a first kth carry-in from a carry-out of a k−1th stage;
a fourth input for receiving a second kth carry-in from a carry-out of a k−2th stage;
a fifth input for receiving a third kth carry-in from a carry-out of a k−3th stage;
a first output for providing a kth result digit;
a second output for providing a kth carry-out; and, an adder for adding said kth digit of said first complex number, said kth digit of said second complex number, said first kth carry-in, said second kth carry-in, and said third kth carry-in to provide said kth result digit and said kth carry-out.

30. The adder circuit of claim 29 wherein said coding system f(p,m)=p\hat{ }m, wherein m is the mth digit in said binary code, wherein p=½*(−1+j*(7\hat{ }(½))), wherein u=1/((7\hat{ }(½)), wherein w=j*(7\hat{ }(½)), and wherein w has a single base −2 binary code K(w)=10101.

31. The method of claim 2 wherein said scaling factor u is selected from the group comprising 1, −1, 1/((2\hat{ }(½)), −1/((2\hat{ }(½)), and 1/((7\hat{ }(½)).

32. The method of claim 4 wherein said scaling factor u is selected from the group comprising 1, −1, 1/((2\hat{ }(½)), −1/((2\hat{ }(½)), and 1/((7\hat{ }(½)).

33. A complex number arithmetic processor for performing an arithmetic operation on at least one complex number, comprising:
a) a control unit for storing instructions;
b) at least one first register responsive to said control unit for reading at least one said complex number Z, each said complex number Z consisting of a real part Xa and an imaginary part Xb, each of said real part Xa and said imaginary part Xb having a separate base 2 binary code;
c) at least one second register responsive to said control unit for reading said arithmetic operation;
d) said control unit being operative to select a coding system f(p,m) having a base p, a scale factor u, and an imaginary unit w, wherein the product of said scale factor u and said imaginary unit w equals the complex unit j and wherein the complex unit j equals the square root of negative one;
e) at least one first encoder responsive to said control unit for coding each said complex number Z to produce a single base −2 binary code K(Z) defined by said coding system f(p,m);
f) at least one second encoder responsive to said control unit for coding said imaginary unit w to produce a single base −2 binary code K(w) defined by said coding system f(p,m);
g) said control unit being operative to perform said arithmetic operation using said single base −2 binary code K(Z) for each complex number Z and said single base −2 binary code K(w) for said imaginary unit w, to produce at least one resultant complex number, each said resultant complex number Z′ having a single base −2 binary code K(Z′); and,
h) at least one decoder responsive to said control unit for decoding each said resultant complex number Z′ to produce a base 2 binary code for the real part Xa′ of each said resultant complex number Z′ and a base 2 binary code for the imaginary part Xb′ of each said resultant complex number Z′; and,
i) at least one third register responsive to said control unit for storing each said base 2 binary code for the real part Xa′ and each base 2 binary code for the imaginary part Xb′ of each said resultant complex number Z′.
